(19) United States
(12) Patent Application Publication
(10) Pub. No.: US 2023/0139524 A1
(43) Pub. Date: May 4, 2023

(54) SYSTEMS AND METHODS FOR CHARACTERIZATION OF AN ASSAY FROM REGIONS OF INTEREST USING OPTICAL REACTIONS

(71) Applicant: LSK TECHNOLOGIES INC., Toronto (CA)

(72) Inventors: Seray CICEK, Toronto (CA); Yuxiu GUO, Toronto (CA); Keith Ian PARDEE, Toronto (CA)

(21) Appl. No.: 17/905,049

(22) PCT Filed: Feb. 26, 2021
(86) PCT No.: PCT/CA2021/050239

§ 371 Date: Aug. 25, 2022

Related U.S. Application Data
(60) Provisional application No. 62/982,323, filed on Feb. 27, 2020.
(60) Provisional application No. 63/031,623, filed on May 29, 2020.

(51) Int. Cl. G01N 21/64; G01N 35/00; G01N 21/25

(52) U.S. Cl. CPC G01N 21/6428; G01N 35/00732; G01N 21/251; G01N 2021/6439; G01N 2035/00752

(57) ABSTRACT

There are provided systems and methods for characterization of an assay from a plurality of regions of interest (ROI). The method including: receiving image data of the assay from the plurality of ROI, the image data including at least two color channels for each ROI; determining a ratio of signal change across the color channels for each ROI; converting the ratio of signal change for each well to a concentration measurement of the assay using a calibration curve, the calibration curve determined from image data of a calibration assay with known concentrations; and outputting the concentration measurement for each ROI.

### TECHNICAL FIELD

The following relates generally to analytical instruments and more specifically to systems and methods for characterization of an assay from regions of interest using optical reactions.

### BACKGROUND

Access to healthcare remains challenging globally, and there is a significant need for rapid diagnostic tests. Such diagnostic tests generally require optical instrumentation for measurement and material characterization. In an example, optical measurement can be accomplished using a plate reader, which provides large-scale parallel measurement. Imaging systems have also become standard equipment in a large number of similar environments and are heavily used in research and clinical laboratories. However, such systems generally have a very high cost and low portability, which limits broad access to optical characterization.

### SUMMARY

In an aspect, there is provided a system for characterization of an assay from a plurality of regions of interest (ROI) on an assay housing, the system comprising: an illumination source to illuminate the ROI; a camera to receive image data of the assay from the plurality of ROI, the image data comprising at least two color channels for each ROI; and a controller comprising one or more processors and a memory, the one or more processors configured to execute: a measurement module to determine a ratio of signal change across the color channels for each ROI and convert the ratio of signal to a concentration determination of the assay using a calibration curve, the calibration curve determined from image data of a calibration assay with known concentrations; and an output module to output the concentration determination for each ROI.

In a particular case of the system, the illumination source comprises a broadband light source with uniform intensity for colorimetric assays.

In another case of the system, the illumination source comprises narrowband excitation light source in combination with an emission filter for fluorescent assays.

In yet another case of the system, the concentration determination is determined by comparing to calibration curve concentrations at end-point readings or comparing to calibration curve concentrations over time-course reactions.

In yet another case of the system, receiving image data of the assay from the plurality of ROI comprises at least one of absorbance, fluorescence, or luminescence readings.

In yet another case of the system, the system performs functions of at least one of a plate reader and a gel imager.

In yet another case of the system, the system further comprising thermal components for on-site incubation using heat convection, conduction, or radiation.

In yet another case of the system, the system further comprising landmarks associated with the assay housing for ROI location identification by the controller.

In yet another case of the system, the landmarks comprise markers positioned on a plate carrier of the assay housing or on four corners of a multi-well plate of the assay housing, and wherein the controller recognizes the landmarks and aligns the landmarks to digital template images of multi-well plates to determine the location of the plurality of ROI.

In yet another case of the system, the system further comprising barcodes associated with the assay housing to determine sample types and analysis protocol by the controller.

In yet another case of the system, the system further comprising an opaque film located in front of the camera to block unwanted light.

In yet another case of the system, the plurality of ROI in the image data can be dynamically defined.

In another aspect, there is provided a method for characterization of an assay from a plurality of regions of interest (ROI), the method comprising: receiving image data of the assay from the plurality of ROI during illumination, the image data comprising at least two color channels for each ROI; determining a ratio of signal change across the color channels for each ROI; converting the ratio of signal change for each ROI to a concentration determination of the assay using a calibration curve, the calibration curve determined from image data of a calibration assay with known concentrations; and outputting the concentration determination for each ROI.

In a particular case of the method, the illumination comprises a broadband light source with uniform intensity for colorimetric assays.

In another case of the method, the illumination comprises narrowband excitation light source in combination with an emission filter for fluorescent assays.

In yet another case of the method, the concentration determination is determined by comparing to calibration curve concentrations at end-point readings or by comparing to calibration curve concentrations over time-course reactions.

In yet another case of the method, receiving image data of the assay from the plurality of ROI comprises at least one of absorbance, fluorescence, or luminescence readings.

In yet another case of the method, the ratio of signal change comprises a ratio of a sum of increasing channel values over a sum of decreasing channel values.

In yet another case of the method, converting the ratio of signal change for each ROI to the concentration determination comprises using single value decomposition to map known concentration data samples collected from a dilution series of end-point reactions to determine unknown samples.

In yet another case of the method, determining the ratio of signal change comprises training an artificial intelligence model with time series reaction data to determine a function that has a consistent increase over time and provides best linearity for the final point in time.

These and other aspects are contemplated and described herein. It will be appreciated that the foregoing summary sets out representative aspects of embodiments to assist skilled readers in understanding the following detailed description.

### DESCRIPTION OF THE DRAWINGS

The features of the invention will become more apparent in the following detailed description in which reference is made to the appended drawings wherein:

FIG. 1 is a diagram of a system for characterization of an assay from a plurality of regions of interest using optical reactions, according to an embodiment;

FIG. 2 is a flowchart for a method for characterization of an assay from a plurality of regions of interest using optical reactions, according to an embodiment;

FIG. 3 is an illustration of 384-well and 96-well micro-well plates;

FIG. 4 shows a diagram of the workings of an example plate reader;

FIG. 5 illustrates a perspective view diagram of an example physical embodiment of the system of FIG. 1;

FIG. 6 illustrates a perspective view diagram of another example physical embodiment of the system of FIG. 1;

FIG. 7 is an illustrative diagram of an embodiment of the system of FIG. 1;

FIG. 8 illustrates an example analysis of a protein titration using the system of FIG. 1 (referred to as PLUM) and a plate reader according to another approach;

FIG. 9 illustrates an example of aligning a virtual template to a micro-well plate captured by a camera;

FIG. 10 illustrates an example of aligning a virtual template to a micro-well plate captured by a camera with empty wells covered using two different types of plates;

FIG. 11 illustrates an example of captured map data and a graph of such captured map data;

FIG. 12 illustrates a diagrammatic example of principles of color absorption and reflectance;

FIG. 13 illustrates an example of a calibration concentration assay and an assay to be determined for a Bicinchoninic Acid Assay (BCA);

FIG. 14 illustrates an output concentration chart of the example of FIG. 13 for a plate reader;

FIG. 15 illustrates an output absorbance reading chart of the example of FIG. 13 for the system of FIG. 1;

FIG. 16 illustrates an output reflected light reading chart of the example of FIG. 13 for the system of FIG. 1;

FIG. 17 illustrates an example of a calibration concentration assay for a malachite green assay;

FIG. 18 illustrates an output concentration chart of the example of FIG. 17 fora plate reader;

FIG. 19 illustrates an output reflected light reading chart of the example of FIG. 17 for the system of FIG. 1;

FIG. 20 illustrates an output absorbance reading chart of the example of FIG. 17 for the system of FIG. 1;

FIG. 21 illustrates an example of a calibration concentration assay for an ammonium assay;

FIG. 22 illustrates an output concentration chart of the example of FIG. 21 for a plate reader;

FIG. 23 illustrates an output reflected light reading chart of the example of FIG. 21 for the system of FIG. 1;

FIG. 24 illustrates an example of a calibration concentration assay for a Bradford assay;

FIG. 25 illustrates an output concentration chart of the example of FIG. 24 for a plate reader;

FIG. 26 illustrates an output reflected light reading chart of the example of FIG. 24 for the system of FIG. 1;

FIG. 27 illustrates outputs of reflected light readings employing Blue channel values over Green channel values from in-field readings from example experiments conducted in Brazil, Ecuador, and Columbia, using the system of FIG. 1;

FIG. 28 illustrates an example of a regions of interest map where well locations are circled as regions of interest;

FIG. 29 illustrates an example of colour change across a plate where positive reactions turned purple and negative reactions remained yellow;

FIG. 30 illustrates an output reflected light reading chart of the example of FIG. 29 for the system of FIG. 1;

FIG. 31 illustrates an example visualization of bands of interest for a commercial imager and for the system of FIG. 1;

FIG. 32 illustrates an example visualization of bands of interest with a longpass filter applied for a commercial imager and for the system of FIG. 1;

FIG. 33 illustrates an example of an imaged western blot using a commercial imager and the system of FIG. 1;

FIG. 34 is a chart showing a sensitivity test for example experiments of the system of FIG. 1;

FIG. 35 is a chart showing the results of a logistic test for the example experiments of FIG. 34;

FIG. 36 is a chart showing the results of a threshold determination for the example experiments of FIG. 34;

FIG. 37 illustrates an example of a calibration concentration assay for an enzyme-linked immunosorbent assay (ELISA);

FIG. 38 illustrates an output concentration chart of the example of FIG. 37 for a plate reader;

FIG. 39 illustrates an output reflected light reading chart of the example of FIG. 37 for the system of FIG. 1;

FIG. 40 illustrates an example of a user interface for determining a type of sample while naming the sample for the system of FIG. 1

FIG. 41 illustrates an example of a user interface for putting samples into different groups where analysis will be made according to sample type for the system of FIG. 1;

FIG. 42 illustrates an example of a calibration concentration assay using fluorescent dye ATTO 520;

FIG. 43 illustrates an example of readings of FIG. 42 in a plate reader;

FIG. 44 illustrates an example of readings of FIG. 42 in the system of FIG. 1;

FIG. 45 illustrates an example of a calibration concentration assay using fluorescent dye ATTO 550;

FIG. 46 illustrates an example of readings of FIG. 45 in a plate reader;

FIG. 47 illustrates an example of a reading of FIG. 45 in the system of FIG. 1;

FIG. 48 illustrates an example of an adaptor using an aluminum block to 96 tubes for analysis, with four corner markers;

FIG. 49 illustrates a front perspective view diagram of yet another example physical embodiment of the system of FIG. 1;

FIG. 50 illustrates a bottom perspective view diagram of the embodiment of FIG. 49;

FIG. 51 illustrates a partial-cutaway front perspective view diagram of the embodiment of FIG. 49;

FIG. 52 illustrates a further partial-cutaway front perspective view diagram of the embodiment of FIG. 49; and

FIG. 53 illustrates a partial cutaway bottom perspective view diagram of the embodiment of FIG. 49.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to analytical instruments and more specifically to systems and methods for characterization of an assay from regions of interest using optical reactions.

Generally, commercial approaches for optical quantification and characterization are expensive and cumbersome (i.e., not sufficiently portable). Advantageously, embodiments of the present disclosure provide a camera-based approach (referred to as “PLUM”), which provides a low-cost and sufficiently portable solution for plate reading and imaging. This portability enables, for example, pop-up diagnostic stations set-up during outbreaks, minimizing the risks involved in sample transportation. As described herein, this approach uses reflected light, rather than absorbance or other modalities, to provide highly accurate functionality at a fraction of the cost of other approaches. In some embodiments, a system is provided that is self-contained, automated, and easy-to-use for broad applications. Such system can perform onboard data collection and analysis, incubation, heating, and other functions with battery-operation. The embodiments described herein can be used in a number of applications; for example, distributed and high-capacity optical measurements for industry, manufacturing, research, healthcare, and education. The embodiments described herein can be advantageously employed outside of a laboratory setting to enable, for example in field analysis of mosquito larva/pupae surveillance, colony counting, hardware identification, ID tracking, and the like.

In some embodiments described herein, there is provided a multi-mode electronic optical reader system that can process a variety of multi-well plate formats (e.g., 96, 384, custom) or electrophoresis gel/blot types with either endpoint or time interval measurements. In contrast to other approaches, some embodiments can use a camera and broadband white light to collect RGB channel values of the reflected light. These RGB pixel values can be converted, as described herein, into quantified data for the calculation of absorbance-equivalents in the target wavelength range. In further embodiments, ratios of other color channels can be used to determine concentration.

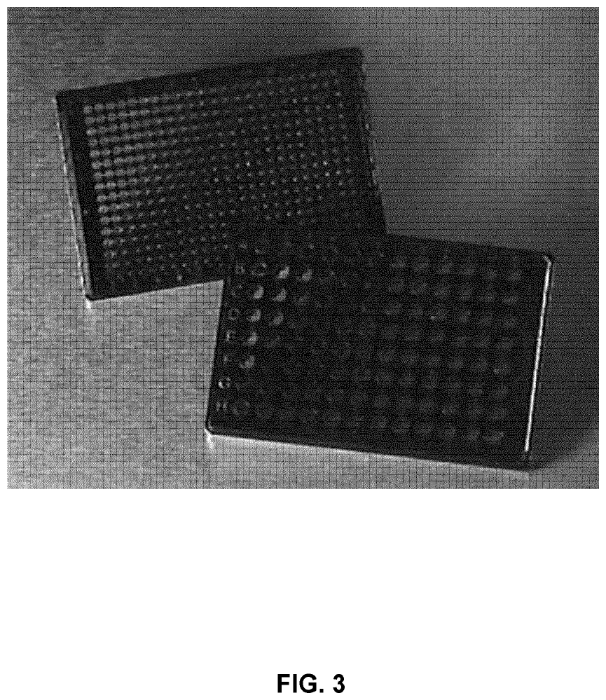

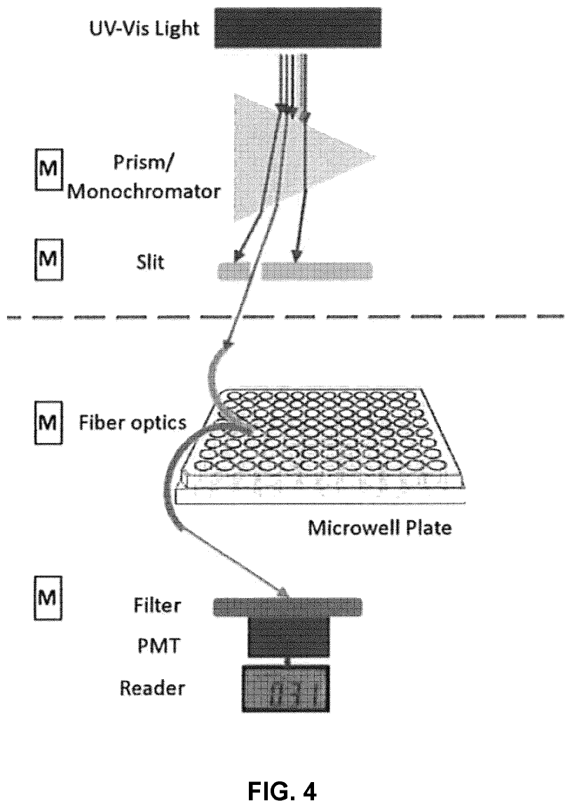

Generally, plate readers are optical instruments that are used to quantify parallel biological, chemical, or physical properties in micro-well plates (an example of a 384-well and 96-well micro-well plates are illustrated in FIG. 3). FIG. 4 illustrates a diagram of workings of an example plate reader. Such plate readers are generally composed of multiple moving parts; these include a monochromator (prism) and fiber optic unit, which both require calibration, and a filter cube and slit, which are used for wavelength selection. The complexity of these components significantly increases the cost of the instrument. In FIG. 4, “M” indicates a moving component. As illustrated, micro-well plates are placed into the instrument and sit between a light source and light detector (photomultiplier tube (PMT)). Each well has a clear window, which allows light to pass through the sample, enabling the relevant property to be measured. Measurements can be collected as an endpoint read or over-time, and are most commonly made in absorbance (colorimetry), fluorescence, and luminescence modes.

Generally, plate readers, such as those described above, work on the principle of colorimetry. In 1868, Louis Jules Duboscq invented the first colorimeter that allowed comparison of two liquids simultaneously. In the time since, colorimeters have become widely used to determine the concentration of an analyte through the measurement of absorbance using Beer Law, which states that the intensity of the color is directly proportional to the concentration of the colored particle. Plate reader-based colorimetric measurement is used to quantify protein and nucleic acid quantification, and pH, for protein detection (e.g. ELISA) and a wide-range of commercially available assays. For example, a Bicinchoninic Acid (BCA) assay uses a colorimetric response that changes from light green to dark purple with increased protein concentration. By monitoring reactions (e.g., at 563 nm), an increase in protein concentration provides a linear optical response.

Fluorescence intensity measurement is a high-cost but highly accurate modality for assay characterization. Fluorescent signals are generated by the excitation of a fluorophore at a specific wavelength, which results in the emission of a signal at a longer wavelength. Capturing the emitted light relies on a filter to separate the resulting fluorescence from the excitation input. Applications of fluorescent-based measurement in research include the quantification of fluorescent signals and reporter proteins (e.g., green fluorescent protein (GFP)) in biochemical, chemical, and cell-based assays.

Luminescence measurement is another type of modality for assay characterization. In this case, chemical and biochemical reactions that result in the generation of light are said to be luminescent. The detection of luminescence is much simpler than fluorescence in that there is no excitation wavelength that needs to be filtered and thus generally only consists of a light sensor. Like GFP, natural luminescent enzymes like luciferase from fireflies have been exploited as protein-based reporters and can be used in cell-based assays.

In other approaches, gel documentation systems can be used where the nucleic acid and protein gels are imaged. In an example, agarose gels can be used for the characterization of nucleic acids that have been labeled with a fluorescent dye. In an example, each band can represent a nucleic acid fragment, with the largest pieces at the top of the gel and smallest at the bottom. Proteins can be similarly characterized using electrophoresis; for example, proteins can be labeled in a Western blot using an antibody conjugated to a chemiluminescent signal.

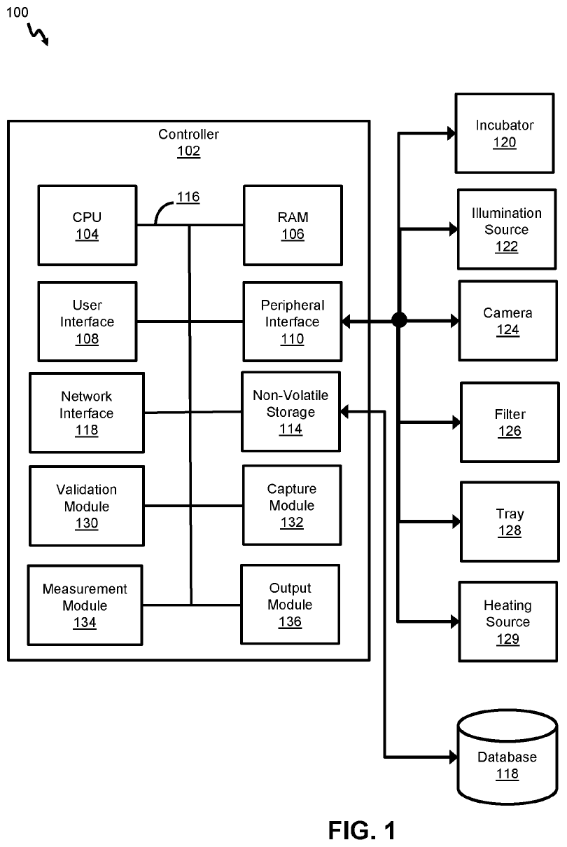

Referring now to FIG. 1, a system for characterization of an assay from a plurality of regions of interest (ROI) using optical reactions 100, in accordance with an embodiment, is shown. FIG. 1 shows various physical and logical components of an embodiment of the system 100. As shown, the system 100 includes a controller 102 that has a number of physical and logical components, including a central processing unit (“CPU”) 104 (comprising one or more processors), random access memory (“RAM”) 106, a user interface 108, a peripheral interface 110, non-volatile storage 114, and a local bus 116 enabling CPU 104 to communicate with the other components. In some cases, at least some of the one or more processors can be a microprocessor, a system on chip (SoC), a single-board computer (e.g., a Raspberry Pi™), or the like. RAM 106 provides relatively responsive volatile storage to CPU 104. The user interface 108 enables an administrator or user to provide input via an input device, for example a keyboard and mouse, or a touchscreen. The user interface 108 can also output information to output devices to the user, such as a display, speakers, or touchscreen. The network interface 118 permits communication with other systems, such as other computing devices and servers remotely located from the system 100, such as for a cloud-computing storage. The peripheral interface 110 permits the controller 102 to communicate with peripheral components of the system 100, or with other computing devices (such as over a network). The peripheral components can include at least one of an incubator 120, an illumination source 122, a camera 124, a filter 126, a tray 128, and a heating source 129. Non-volatile storage 114 stores the operating system and modules, including computer-executable instructions for implementing the operating system and modules, as well as any data used by these services. Additional stored data can be stored in a database 118. During operation of the system 100, the operating system, the modules, and the related data may be retrieved from the non-volatile storage 114 and placed in RAM 106 to facilitate execution.

The system 100 further includes a number of conceptual modules that can be executed on the CPU 104; in some embodiments, a validation module 130, a capture module 132, a measurement module 134, and an output module 136. In some embodiments, the modules of the system 100 are stored by and executed on a single computing device. In other embodiments, the modules of the system 100 can be distributed among two or more computing devices that may be locally or remotely distributed. In some cases, the functions and/or operations of the modules can be combined or executed on other modules.

In contrast to absorbance mode readers, embodiments of the present system 100 can advantageously be used to convert reflected RGB light to generate absorbance equivalent measurements. In further embodiments, this approach can be used to convert readings from various camera-based devices (e.g. smartphones) to absorbance-equivalent measurements.

In most cases, the assay can be either a plate array or a gel array. As described herein, the regions of interest (ROI) can be detected based on the array type.

The heating source 129 can use an indirect approach (for example, a heater with a fan) or a direct approach (for example, an aluminum block or electric current). With the indirect approach, the heating source 129 includes a number of thermal components located at a distance from the samples in the assay; enabling an even heating. With the direct approach, the heating source 129 includes a number of thermal components directly in contact with the samples of the assay. In an example, the thermal components can have a temperature range from room temperature to 120° C.

As described herein, to enable a camera-based reader in accordance with the system 100, various types of receptacles for housing the assay at regions of interest can be used. In some cases, modified multi-well plates of various sizes can be used, with one or more wells being the region of interest housing the assay. In some cases, an opaque film (e.g., aluminum PCR (polymerase chain reaction) film) can be applied to the multi-well plates to increase image contrast and quality. In some cases, bright acrylic discs can be added to the multi-well plates so that the system 100 can align images to digital templates for data collection. In some cases, electrophoresis gel or blots can be used to house the assay at one or more regions of interest in the gel or blot. In some cases, a plurality of tubes can be used to house the assay, with each tube being a region of interest housing the assay. In some cases, an ultraviolet (UV) transparent glass tray can be used with multiple sections for housing the array as the regions of interest.

Advantageously, embodiments of the present system 100 can use a camera 124 as a single sensor for a plate reader; compared to 8-12 light sensors in other approaches. Additionally, to advantageously remove any biases due to light source type, the system 100 can use an illumination source 122 with even illumination that mimics sunlight; common white light sources generally do not have this property. Common illumination sources have a high blue channel signal intensity. This biases readings towards high blue channel readings independent of the assay itself, resulting in inaccurate measurements. In most cases, as the approach described here depends on change in the color values, two color channels used for analysis should have relatively similar level of even illumination. Advantageously, embodiments of the present system 100 can use a reduced number of filters 126 needed to collect a fluorescent signal compared to other approaches. In some cases, the system 100 can use inexpensive longpass filters in combination with Bayer filters found on cameras to create a bandpass filter set. In some cases, fluorescent intensity can be subtracted to determine the light that is blocked by the bandpass filter.

Advantageously, the present inventors determined that reflected light can be used to characterize reactions by monitoring changes in the color channels. Example experiments, described herein, show that Red, Green and Blue channel values of the reflected light can be used to quantify colorimetric change. This approach can significantly reduce the number of components needed and can eliminate the need for most moving parts that require calibration.

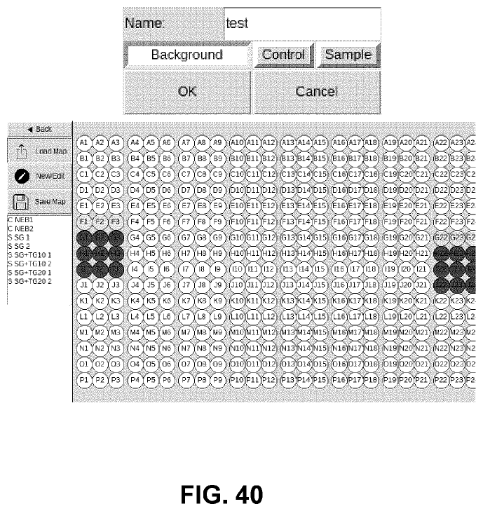

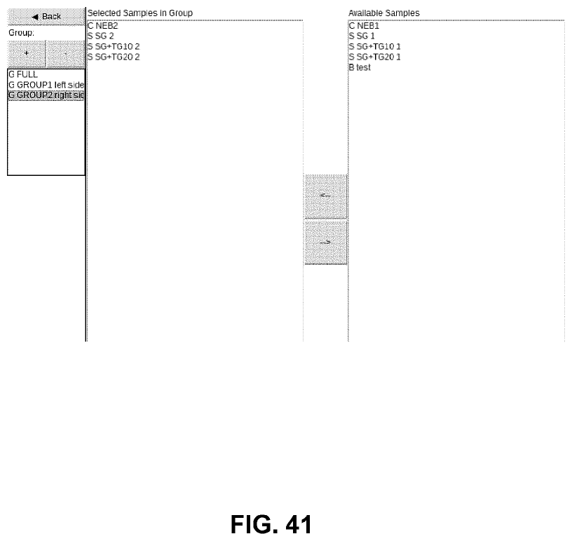

Advantageously, in some embodiments, the system 100 can automatically align data images of the regions of interest with markers situated in predetermined positions relative to the regions of interest. In an example with multi-well plates, markers can be mounted to the plates (for example, acrylic markers at each of the four corners of the plate) or the tray and adaptor carrying the plate, for processing discrete values from each well. This can enable a significant reduction on the cost of hardware. In this way, the system 100 can be configured to recognize any type of plate; commercial or custom-made. Additionally, the system 100 allows users to create group maps for samples, which enables automated data analysis and result-based decision making (e.g. diagnostic positive or negative). In some cases, a user can: (1) set a type for each reaction, by associating a label such as “background”, “control” or “sample” to the detected regions of interest (as illustrated in the example of FIG. 40); (2) group labelled reactions for automated graphing (as illustrated in the example of FIG. 41). The system 100 can automatically generate test results based on color changes, as described herein.

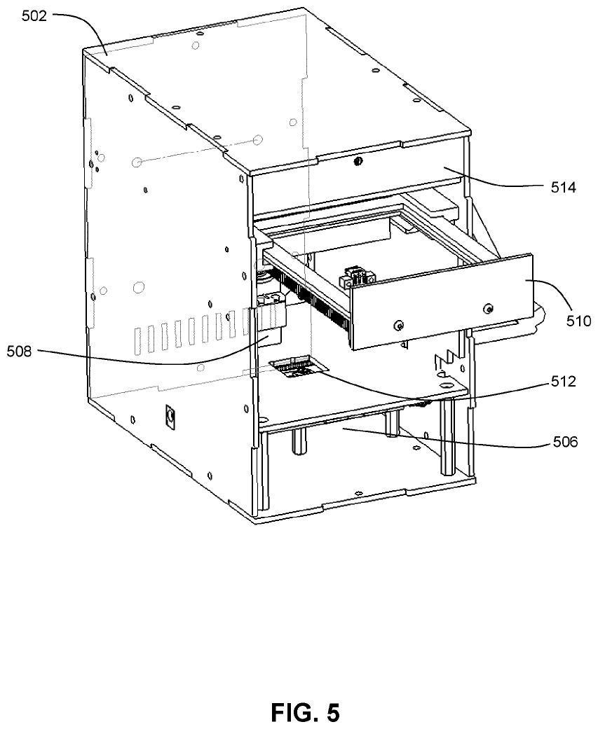

FIG. 5 illustrates an example physical embodiment of the system 100. In this example, the system is enclosed in a physical enclosure 502. The user interface 108 communicates with, for example, a touchscreen device. The controller 102 is located in a housing 506 located beneath the enclosure 502. The peripheral interface 110 interacts with a motor 508 for controlling the tray 128 as a motorized tray 510, the camera 124 located at the bottom 512 of the enclosure 502, the illumination source 122 (in this example, a light box 514 with white LEDs), the incubator 120 (including temperature and/or humidity sensors) and the heating source 129 located at the top of the enclosure 502. In some cases, the housing can be made from opaque acrylic sheets to prevent the ambient light from interfering with measurement.

Thus, the above embodiment of the system 100 can be thought of as containing three overarching sections: 1) a light box with broad-band or narrow-band lights as the illumination source 122, 2) a set of filters 126 with specific transmission parameters, and 3) a digital camera 124 with high pixel resolutions. This efficient hardware architecture contrasts sharply with the complexity of other plate readers that involve high-cost mechanical parts.

In the above example embodiment, the addressable lightbox 514 contains one broadband light source and multiple sets of excitation LEDs for the fluorescence mode. This edge-lit design can provide substantial cost savings due to the reduced number of LEDs required (edge-lit has 8 LEDs while other approaches generally are back-lit and require 54 LEDs). The motorized tray 510 facilitates loading of the assay housing (e.g., multi-well plate) into the device while a heat source and a temperature probe allow for constant incubation (>25° C.) throughout experiments. A filter wheel can be used to select a bandpass filter and can be controlled automatically by the controller 102. In this example, an 8-megapixel camera is used to collect image data and split the incoming light into red-green-blue (RGB) channels. The on-board controller 102 removes the need for an additional computer station.

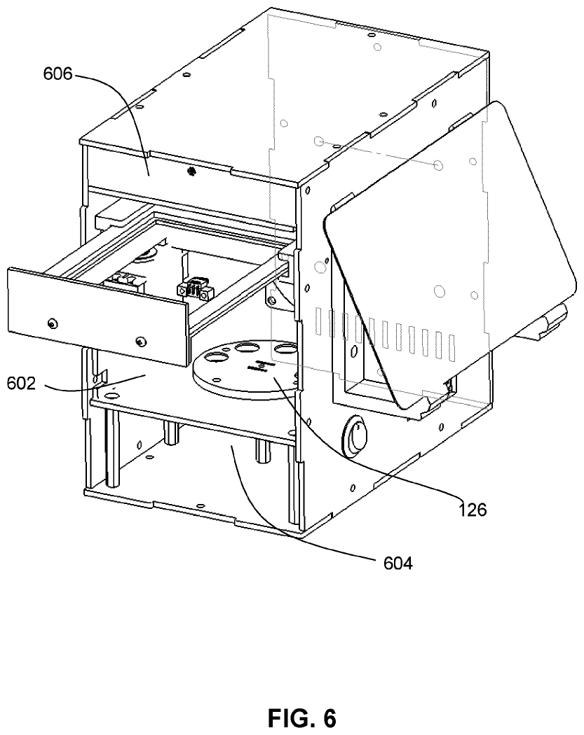

FIG. 6 illustrates another example physical embodiment of the system 100. In this example, the enclosure is split into two compartments: a detection chamber 602 and a control chamber 604. In this example, the lightbox 606 illumination source 122 is located at the top, while the camera and the filter 126 (here a motorized filter wheel) is located in the detection chamber 602. In some cases, the filter wheel can have an empty location to enable absorbance-equivalent measurements.

In the above example, the detection chamber 604 contains the lightbox, a motorized tray, the motorized filter wheel and the camera. This configuration allows for clear visualization of the plate from the bottom and capture of the image data. On the side panels, the detection chamber houses a fan-based air incubator 120 for heating, temperature sensor for recording, two tray rail guides, a continuous servo motor for controlling the tray and a microswitch for homing the tray. The servo motor gears engage with tray teeth to open and close the tray.

In an embodiment, the motorized tray 128 can be used to ensure proper alignment of imaging. Once the plate is delivered into the view of the camera, the intermeshed gears of the servo motor provided resistance to lock the plate in place, ensuring that there is no movement while the experiment is running. To do this, an automatically controlled, geared tray track can be used to move the tray in and out. The tray can be configurable to hold any type of assay housing, such as a micro-well plate or a UV transparent glass tray, that can be placed in the device for imaging of DNA and protein gels and membranes. In some cases, a pressure sensitive switch can be placed at the end of the tray track, so the device automatically stops the servo motor when the loading is completed.

In some cases, the system 100 can have a backlit illumination source 122 (for example, one with 54 units of high CRI Yuji LEDs that closely mimic sunlight wavelength distribution). In other cases, to allow for fluorescent imaging while keeping the cost low, an edge-lit illumination source 122 can be used (for example, with an acrylic light guide panel). In an example, the edge-lit design can contain 12 high CRI YUJI LEDs and 4 sets of 8 narrow wavelength Rebel LEDs for the excitation of fluorescent molecules. In this example, the LEDs can be controlled with a custom designed addressable multiplexer PCB unit controlled by the controller 102. In some cases, for the selection of emission wavelengths, the filter 126 can be a filter wheel (for example, one capable of housing four long pass filters and an empty position). The filter wheel can be actuated with a servo motor that allows for precise axial rotation of the wheel and alignment with the camera.

In particular embodiments, referred to as a fluorescent mode, the system 100 collects data with the help of excitation LEDs and emission filters. The emission spectra that reaches the camera after the longpass filters are quantified by using the corresponding RGB channel values.

In another example of an edge-lit illumination, the light box in the system 100 can include an edge-lit frame composed of a 3-mm acrylic sheet and LEDs with either broad or narrow spectra. The white broad-wavelength LED generates a full visible spectrum, which has representation of wavelengths from 380 nm to 740 nm. The narrow-banded LEDs have high emission peaks at specific wavelength ranges. Specifically, the royal blue LEDs have a wavelength peak between 440 nm to 460 nm, blue LEDs have a wavelength peak between 460 nm to 485 nm, cyan LEDs have wavelength a peak between 490 nm to 515 nm and the amber LEDs have peaks in 585 nm to 595 nm. The edge-lit light box is designed so that that all the LEDs face inwards on each side of a mirrored clear acrylic.

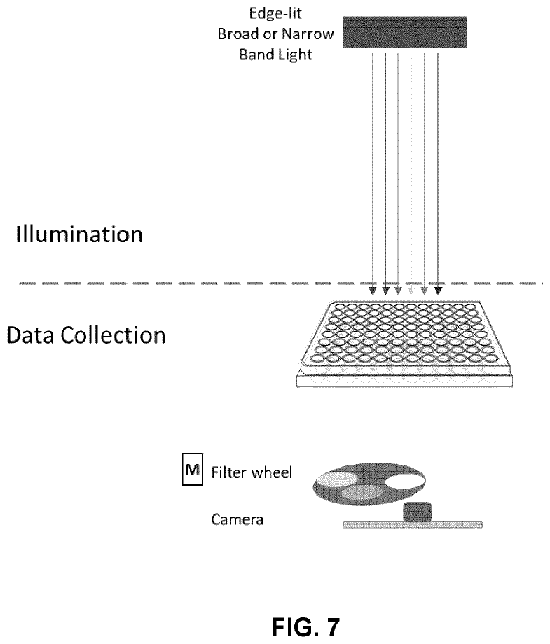

FIG. 7 shows an illustrative diagram of an embodiment of the system using a filter wheel as the filter 126. In this embodiment, optical components of the system 100 can be stationary with the exception of the rotating filter wheel. This can advantageously make the system 100 more robust and allow it to be portable. The set of filters assembled into the wheel-shaped base can be controlled by the controller 102. In an embodiment, the filter wheel can contain multiple openings that provide the capacity for filters, leaving one slot open for unfiltered light collection for absorbance-equivalent readings. In an example, the four longpass filters can have cut-off wavelengths at 515 nm, 540 nm, 570 nm, and 660 nm respectively. After the illumination reaches the sample, light is reflected from the sample. As the reaction takes place, reflected light that reaches the camera in presence or absence of a filter produces a shift in color channel intensities of the camera.

In an embodiment, the camera 124 can be a single-chip digital image sensor; however, any suitable camera can be used. In some cases, the camera 124 sensor can have an arrangement of RGB (red, green, blue) colour filters. In some cases, the camera 124 can have a tunable focal length that is set to focus at the plane of the assay housing (e.g., multi-well plate). Advantageously, the system 100 can use a fixed camera (e.g., non-motorized), in contrast to the multiple and motorized sensors used in other plate readers. The light box, filters, and camera enable the system 100 to perform multimode measurements with high flexibility. With the coupled light source and filter, the camera is able to capture the optical signals through the embedded red, green and blue colour sensor arrays. For absorbance assays, the white light with a full emission spectrum is used, allowing the camera to capture broad-spectrum reflected light from the sample. For fluorescence assays, the combination of coloured LEDs and filters are used; the selected LEDs have wavelength peaks that fall into the excitation wavelength for commonly used fluorescence samples, while the longpass filters block the background and allow the emission light to reach the camera (e.g. fluorescent label ATTO 520 and ATTO 550). For the detection of luminescence signal, the camera 124 has the advantage of adjustable exposure time and analog gain to capture the low emitted light from bioluminescence or chemiluminescence substances.

The system 100 advantageously utilizes an analysis approach that uses reflected light data instead of absorbance for colorimetric applications. This analysis approach quantifies the shift in the red-green-blue (RGB) channel values to create an estimator of the analyte concentration. In an embodiment, this can be achieved by determining channel values that correlate with calibration curve concentrations in end-point readings or with increase in analyte concentration over time for time-based assays. A function can be generated that takes RGB channel values as input and maps them to an estimator value, referred to as signal. The estimator value can then be linked to concentration of an analyte with linear, or sigmoidal, regression fit; referred to as a signal calculator.

The signal calculator converts RGB channel values collected by a camera to a ratio (referred as an estimator). A set of standards with known concentrations can be used to create a calibration curve. A standard that does not contain the analyte of interest is referred as blank. An image of the plate containing the standards and blank is captured. From the image, RGB channel values for each region of interest containing a standard are averaged separately for each channel. Mean RGB channel values are used as an input to signal calculator. Based on the mean of the RGB values of the blank, and at least some of the rest of the standards, the system 100 generates possible equations that output the estimator. Signal Calculator equations are ratios of combinations of increasing color channel values (for example, R, R\hat{ }2, R+B, or the like) over combination of decreasing color channel values (for example, R+B, R*B, or the like). Based on the estimator values of the standards, the calibration curve is used to generate a relationship equation that maps the relationship between the estimator and the known concentrations. In some cases, goodness of fit of the relationship equation (R-squared value) to the data points is used to determine the signal calculator equation that gives the best match. An estimator value of an unknown concentration can be used as an input to calibration curve equation to determine the unknown concentration.

With the signal calculator, the system 100 analyzes an increase or decrease in RGB values. The color channels with significant changes are represented as a ratio of increasing color values over decreasing color values. This change can be represented as a ratio that allows for the quantification of the color transition and minimizes well to well illumination variation.

In other cases, colour change can be determined using single value decomposition (SVD). SVD is a matrix decomposition approach for reducing a matrix to its constituent parts. In the system 100, SVD can be used to map the relationship between known sample concentrations and RGB channel values. This allows the system 100 to provide a better estimation for the standard curve equation that predicts the concentration of a solution. In this way, SVD can be used for taking the reflected light data to determine measurements of absorbance equivalent data. Each color channel can have its own contribution to the concentration reading. In further cases, SVD can be used as an alternative approach to determine the estimator.

In some cases, in order to reduce the cost of the system 100, the filter 126 can be comprised of long pass filters instead of expensive bandpass filters. To achieve the level of narrow wavelength detection, higher wavelength bandpass filter values are subtracted from lower wavelength bandpass filter values. Subtraction can be used to select for light that falls into a narrower band without using bandpass filters; which can be expensive.

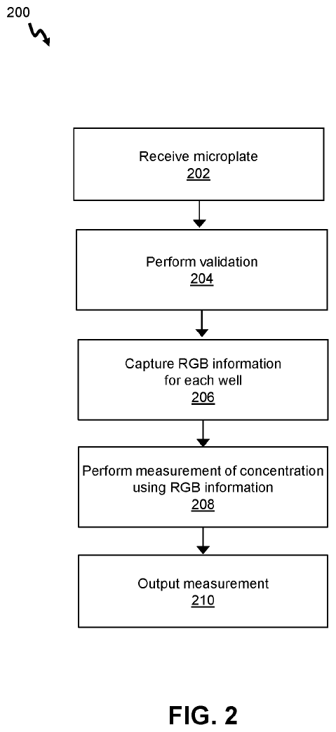

Turning to FIG. 2, a flowchart for a method for characterization of an assay from a plurality of regions of interest (ROI) using optical reactions 200, in accordance with an embodiment, is shown. At block 202, a micro-well plate is received by inserting the micro-well plate into the tray 128. In an example, the user can insert a plate into the system 100 using the motorized tray 128.

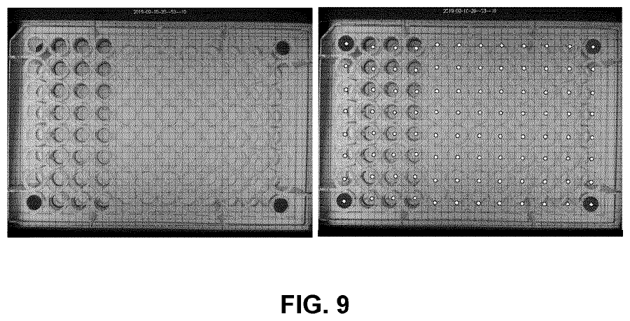

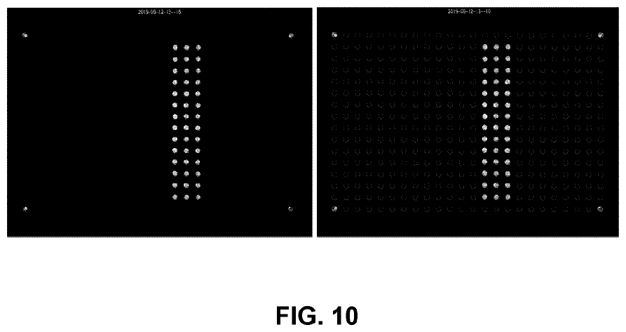

At block 204, the validation module 130 can perform a validation. The validation ensures the plate is in the view of camera 124 and aligned with a corresponding digital map that allows optical measurements to be attributed to each well of the micro-well plate. This latter step generates a virtual template of the plate, in which the regions of interests (ROI) can be aligned with micro-well plate pattern. In some cases, to make sure high-quality image data is obtained, a user can use the user interface 108 to align a virtual template (in an example, visualized by an array of dots) to the captured plate; as illustrated in the example of FIG. 9. In some cases, to help with recognition of the plate, reusable coloured acrylic disks, which can be referred as “markers”, can be placed on the plate; for example, one at each of the four corners. The validation module 130 can then determine a template by aligning the markers to the corners of the template. FIGS. 9 and 10 illustrate plate validation through use of the four corner markers to determine a virtual template that contains the ROIs (region of interest) in 96 well plate and 384 well plate. For FIGS. 9 and 10, the left image is a captured image and the right image is the well location determined by the validation module 130 as shown by the circle markings. Region of interest is the areas of the captured image that contains pixel information of the samples for data analysis. In order to avoid bubbles that can interfere with the reading, a certain area can be selected for further analysis. Region of interest determination can be manually determined by the user by selecting or locating a selected area; or it can be determined automatically using a current validation approach.

In some cases, the alignment performed by the validation module 130 can include landmark-based automated alignment of images. In this case, the validation module 130 automatically aligns images with digital templates of the multi-well plates. In this way, the validation module 130 recognizes markers (in some cases, re-useable markers) that are placed in the four corners of the multi-well plate. In some cases, such recognition can be based on color or shape. The landmark-based alignment can be performed before or after image acquisition, allowing the captured images to be automatically partitioned into optical data sets for each well. The validation module 130 can, for example, use computer vision to determine the landmarks through unique pattern identification (for example, recognizing squares or circles).

In some cases, the multi-well plate can have a two-dimensional or three-dimensional barcode (for example, a QR code) or other visible data encoding. This barcode can be scanned by the validation module 130 via the camera to enable automated input of the sample types and analysis protocol. The barcode can encode information related to, for example, cartridge type, protocol parameters (temperature, light info, filter info, etc.), and linkage to a backend database. By recognizing the barcode, the validation module 130 will be able to execute the method of the present embodiments. This advantageously replaces manual data entry and manual matching of wells with sample types.

In an example, the validation module 130 can recognize the barcode through an edge detection method and then decode the type of assay/cartridge. For each type of assay/cartridge, the validation module 130 will either match a given map to the image received from the camera based on the landmark (as described herein), or the validation module 130 can use computer vision to recognize the ROI in the image (for example, using bands detection).

Once the template is acceptable, at block 206, the capture module 132 can instruct the illumination source 122 to illuminate and instruct the camera 124 to receive an image. In this way, RGB information for each region of interest can be captured by the capture module 132 from the image; as illustrated in the example of FIG. 10.

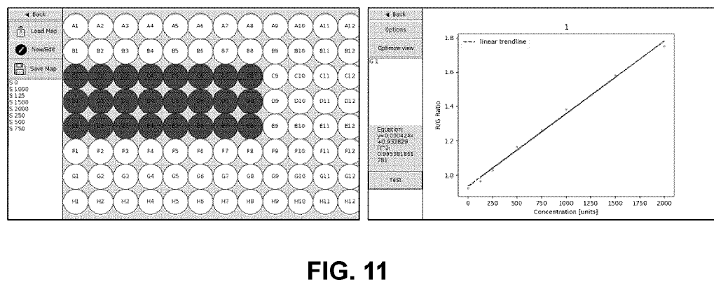

In some cases, the capture module 132 can permit determination of sample identity (e.g., control, test, and the like) for each well location. As images are captured, data can be automatically graphed according to the sample identity map generated during the above plate validation; as illustrated in the example of FIG. 11. In this way, captured image data and map data can be integrated into the system 100 to provide quantitative analysis. In some cases, resulting data and raw information from the map and images can be outputted.

For absorbance measurements, the system 100 can employ an optical principle that is advantageous over other plate readers and, in some cases, can then provide an absorbance-equivalent result. Other plate readers generally track changes in the absorbance of a narrow range of wavelengths; for example, following the Beer-Lambert law that states that the absorbance of light at a fixed wavelength is directly proportional to its concentration. Thus, the wavelength of interest is isolated from the light source and passed through the sample of interest (e.g. sample in multi-well plate). Any observed decrease in transmitted the light is monitored and converted into an absorbance value. The calibration curve can be plotted and used to determine the concentration of an unknown solution.

In contrast to the above, at block 208, the measurement module 134 can perform measurement of concentration by measuring signal change across red-green-blue (RGB) channel values collected by the camera 124. When reactions result in a colour change, the colour shift in a sample can be captured by the reflected light that hits the camera 124, leading to a change of RGB signals recorded by the camera 124. In the fluorescence mode, a coloured LED illumination source 122 and a longpass filter 126 can be used to isolate the signal of interest. Based on the RGB values collected before and after the reaction (or in comparison to control and standard curve values), the measurement module 134 is able to quantify any colour-shift that is detectable by the camera and increase the signal amplitude using reflected light analysis. In the luminescence mode, the camera 124 can be used to detect and quantify light generated by samples. In the case of absorbance measurement, transmitted light is isolated by additional set of filters. Then the transmitted light is used to generate the calibration curve equation without any further manipulation.

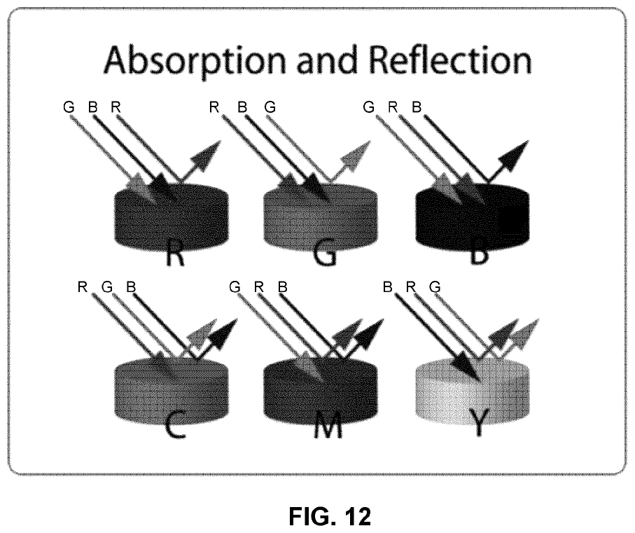

The reflected light analysis is based on RGB colour mixing. The light hitting an object contains the light that can be captured by red, green and blue sensors. The recognized colour is based on the light reflected from an object of interest. If red, green, and blue light are received alone, they can be recognized as primary colours respectively. If the combination of green and red colours with the same intensity are received, it can be recognized as a yellow colour. The same colour mixing concept leads to the combination of green and blue producing cyan, and red and blue producing in magenta. When the light hits an object, or a solution in the case of bioassays, some light is lost in the absorption of the object while the rest of the light is reflected and received by the camera's sensor. For example, when a cyan object is illuminated by white light, the red light is absorbed and the rest (green and blue) is reflected. If a sample color changes from cyan to magenta, the transition means the camera sensor will then receive more red light and less green light. A diagrammatic example is illustrated in FIG. 12. In contrast to other plate readers that quantify the decrease in the single wavelength absorbance, the system 100 tracks the change in reflected light through the spectrum of RGB values.

In some cases, the measurement module 134 can determine expressions of RGB values collected from a dilution series of an end-point reaction and selecting a function that gives a result with the best linearity. Such function can be represented as a ratio of a sum of increasing channel values over a sum of decreasing channel values. Generally, a serial dilution is a series of sequential dilutions used to reduce analyte concentration to a wider range of concentrations. Generally, the serial dilution is prepared by users and the concentration can be entered manually by the user through the user interface 108. Generally, the serial dilution can be used to determine the correlation between the concentration of the analyte and color output, which is used to determine the unknown concentration. Single value decomposition can be used to map known concentration data samples collected from dilution series of end-point reactions in order to determine unknown samples. In some cases, the measurement module 134 can use a machine learning model, that is trained with known time series reaction data, to find a function that shows consistent increase over time and gives best linearity for the final point.

In an example, the machine learning model can be used to determine the initial color and final color of the reaction, which can be used by the controller 102 to determine the output. In some cases, supervised machine learning models can be used to classify different reactions. The input for such models can be the RGB values and shape of the ROI, and an output of such models can be the biological related information. In further cases, machine learning models can also be used against data collected for epidemiology information.

At block 210, the output module 136 outputs the measurements of concentration determined by the measurement module 134. The outputting can include, for example, displaying on a user display via the user interface 108, storing in the database 118, or exporting to another system via the network interface 118, such as a cloud computing storage over a network. In some cases, the output can include a visualization, such as a chart, of the measured concentration.

In some embodiments, a method performed by the system 100 can include receiving image data of the assay from the plurality of wells, the image data comprising at least two color channels for each well; determining a ratio of signal change across the color channels for each well; converting the ratio of signal change for each well to a concentration measurement of the assay using a calibration curve, the calibration curve determined from image data of a calibration assay with known concentrations; and outputting the concentration measurement for each well.

In further cases, the system 100 can perform image analysis covering absorbance, fluorescence and luminescence illumination reading modes for single timepoint reading and time-course reactions. In some cases, the user can determine the type of illuminance during protocol set up. For one reaction, user can set different illuminance settings to read (i.e. sequential absorbance and fluorescence reading can be performed at each timepoint if necessary).

Time-course readings are multiple end-point readings collected over time with pre-set time intervals in between. End-point readings are a single data set (i.e., one image), where the data set contains initial (background without analyte) and final data point (with analyte). End-point readings are analyzed based on known physical quantities (i.e. concentration or dilution factor) in comparison to a relative reading. While time-course readings are analyzed based on the relative reading in comparison to time.

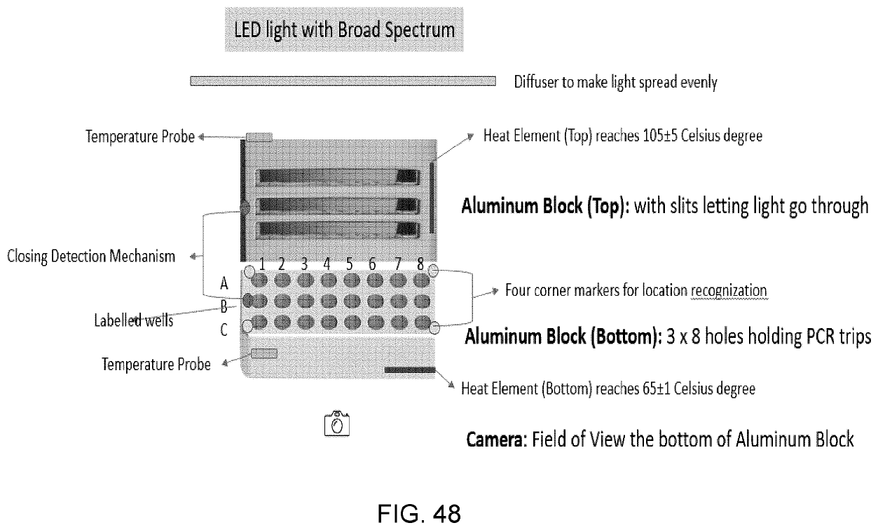

In another aspect, there system 100 can be encompassed in a single device, as illustrated in FIG. 48. The device can include one or more of: a broadband light source with uniform intensity for colorimetric assays; a narrow band excitation light and bandpass filter for fluorescent assays; controllable light source to create dark environment for luminescent assays; a camera for collection of RGB channel values; an adaptor that holds the sample in place; thermal components which can provide ambient incubation; a marker system to help system to align the reading template; auxiliary components, gas source and motorized tray to facilitate the reactions; connection to a controller processing unit for computation; a display unit to receive input and allow user guided operation; and an enclosure to enclose the components together and block ambient light. The adaptor can have standard or custom format. The thermal components can have at least two formats: (1) the incubator that provides heat transfer inside the device, and (2) an aluminum block with holes that provides on-site incubation directly to the tubes/plate. FIG. 48 illustrates an example of using aluminum block as an adaptor to 96 tubes for analysis (with four corner markers).

In further cases, the above device can include a landmark-based method generating automated alignment of images: automatically aligning images with digital templates of multi-well plates; recognizing (re-useable) markers that are placed in the four corners of the multi-well plate. This approach can be performed before or after the image acquisition process, allowing the collected images to be automatically partitioned into optical data sets for each well. RGB values for each of the respective regions of interest (ROI) can then be collected for analysis as described herein.

In further cases, opaque film can be used to enhance the automated alignment of the images. Opaque film can be used to block unwanted light from empty well from the plate. Film can be used with direct or indirect touch with the plate and camera. The location of the opaque film can be on top or bottom of the assay plate but should be in front of the camera. Blocking unwanted light can avoid overexposure problems generally present in digital photography. The empty wells may have strong light intensity passing through which will re-adjust the white balance of the digital camera; which may result in unrecognized color change in the wells with reactions. Direct or indirect touch means the blocking can be applied either in directly contact with the plate or without touching the plate. The blocking film can be applied to the bottom of the plate but still in front of the camera. Since the bottom of the plate can be clear, the film can be applied either on top or under the bottom of the plate.

For determining the regions of interest (ROIs), demarcation of the pixels to be used for RGB values can be static or dynamic. Dynamic recognition can use, in some cases, pattern identification; for example, recognizing a number of bands in a gel assay. Static recognition can use, in some cases, map alignment; for example, using a pre-defined set of ROIs to analyze an image of a plate. The region of interest can be tailored for each multi-well plate format. The location of the ROI can be positioned anywhere within the circumference of the well so as to collect the highest quality data from each well. The ROI does not need to be limited to the number of pixels and could range from one to much larger values. The system 100 can serve as both a plate reader and gel imager, combining plate reader and gel imager functionalities into a single instrument. The system 100 enables a programmable platform to collect optical data. Functions can be determined by any suitable approach, or combination of approaches, such as: by creating all possible algebraic expressions of RGB values collected from dilution series of an end-point reaction and selecting the function that gives the output with the best linearity; by representing the function as a ratio of sum of increasing channel values over sum of decreasing channel values; by use of single value decomposition to map known concentration data samples collected from dilution series of end-point reactions and determine unknown samples; or by training an artificial intelligence model/algorithm with time series reaction data can be used to find a function that shows consistent increase over time and gives best linearity for the final point. Artificial intelligence can be used to automatically determine a ratio of signal change by training the artificial intelligence model with time series reaction data to determine a function that has a consistent increase over time and provides best linearity for the final point in time. The artificial intelligence model can use previously collected data to determine an optimal color combination to deliver an equivalent outcome as a plate reader or gel imager. Artificial intelligence models can also be used to estimate a best precise concentration and experiment result, and be used to estimate viral load or quantity based on the data curves collected over time or end-point-results.

Following additive mixing color theory, the system 100 can perform selection of the function that gives the output with the best linearity. Color channels that have a change in value are binned as increasing values and decreasing values. Then, a function is created as the ratio of value-increasing color channel over value-decreasing color channel for color. In some circumstances, the combination of addition, subtraction, and multiplication of RGB channels can be used. Thus, a calibration curve can be generated to determine the function that gives the best fit (high R-squared value) between the known concentrations and function outputs.

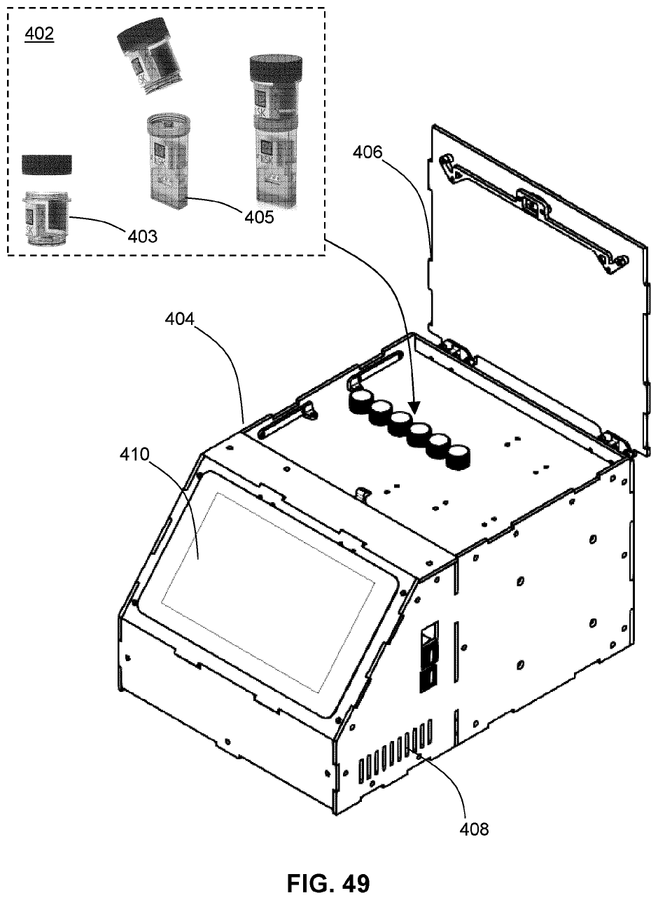

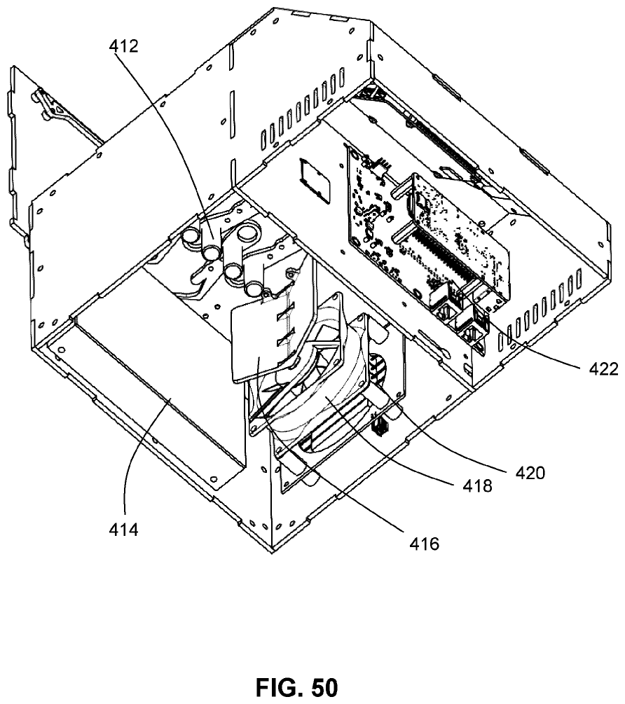

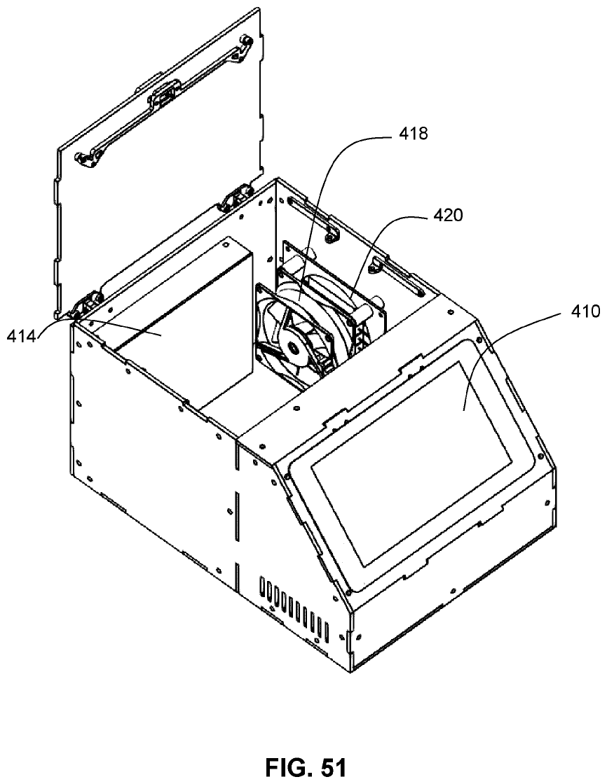

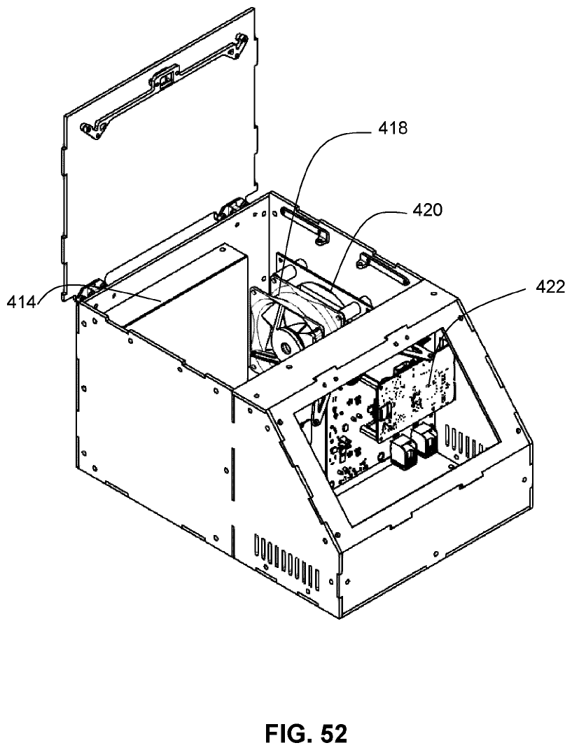

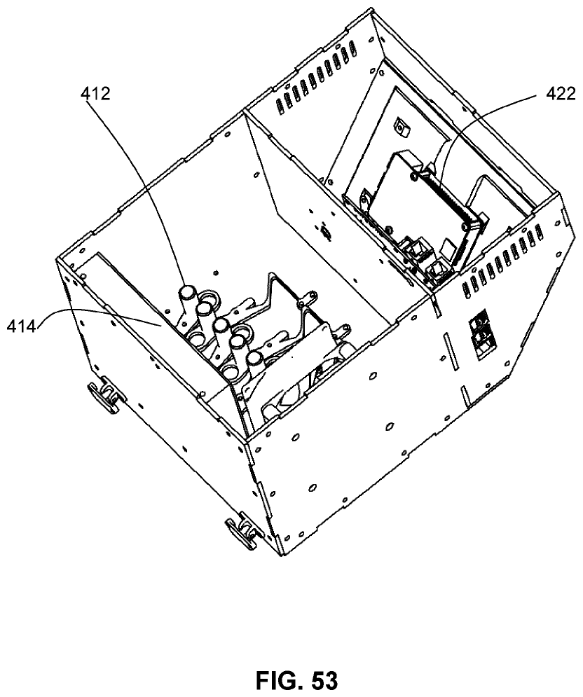

FIGS. 49 to 53 illustrate a further embodiment of the system 100. In this embodiment, there includes a plurality of cartridges 402 to each hold samples of the assay. This embodiment further includes circuitry 422 comprising the controller 102. Each cartridge 402 includes a sample collection receptacle 403 mounted to circuitry configured to perform one or more of the functions performed by the validation module 130, the capture module 134 and/or measurement module 134. The enclosure 404 includes a lid 406 and ventilation holes 408. Also included in a touchscreen 410 to act as a user interface. This embodiment includes cartridge holders 412 incorporate self-closing pins. Also included is a lightbox 414 to provide the illumination. The heating source 129 encompasses a local overheat guard 416, a fan 418, and a heater 420.

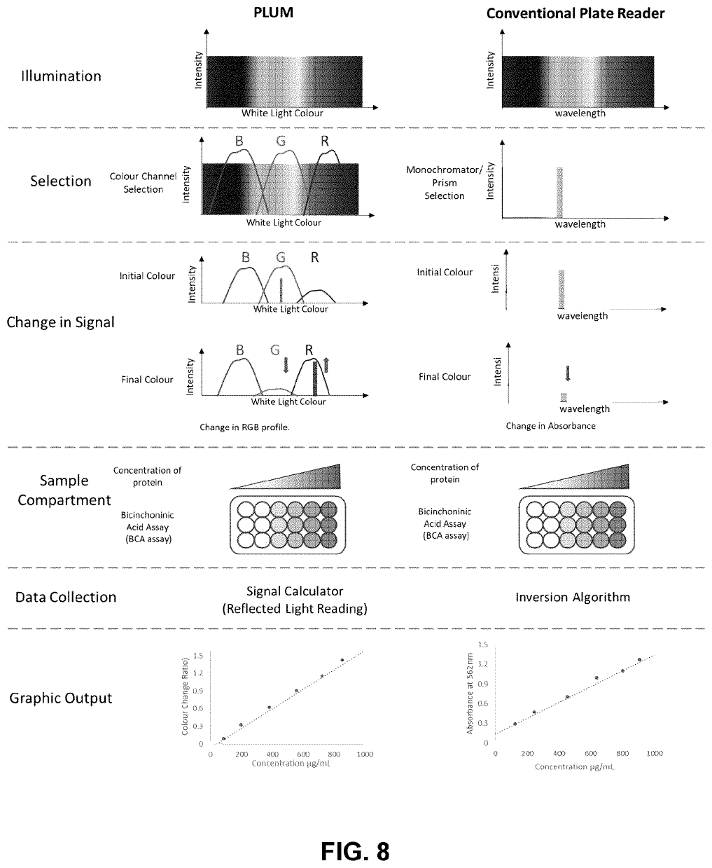

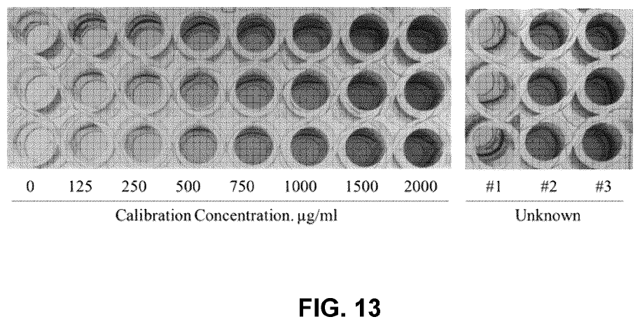

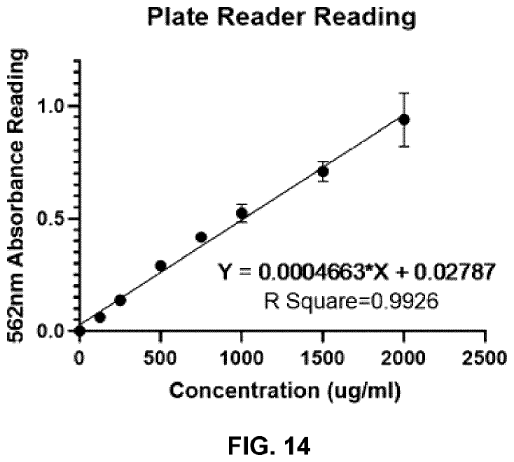

As an example, the present inventors conducted an example experiment to compare the present embodiments to the Beer-Lambert Law using a Bicinchoninic Acid Assay (BCA). In this assay, the originally cyan-green blank sample turns purple in proportion with the addition of protein (working range 25-2000 μg/mL). For the purple transformation, FIG. 13 illustrates a calibration concentration assay and an assay to be determined (unknown samples). FIG. 8 illustrates the example experiments' analysis of a protein titration in the BCA assay using the system 100 (referred to as PLUM) and a plate reader according to another approach. The system 100 uses the shift in primary colors (RGB) to quantify reactions, while the other plate reader relies on Beer-Lambert Law to quantify absorbance via a decrease in transmittance at 562 nm; which is green light in the visible spectrum. As illustrated in FIG. 8, as cyan color turns to purple, red channel values increase while green channel values decrease. In a plate reader according to other approaches, transmittance for the BCA is measured at 562 nm wavelength, which corresponds to the green channel in a camera, as illustrated in FIG. 8. The example experiments determined concentrations of three samples by using calibration curves created from RGB data collected by the system 100 and analyzed the data with the signal calculator. These results were compared to concentrations calculated by using the calibration curve generated using a commercial Biotek™ Plate Reader that monitored the assay using 562 nm absorbance. In the assay of the example experiment, a series of BSA protein concentration standards were added to BCA solutions in a multi-well plate and measured using both a plate reader according to other approaches and by the system 100. In the plate reader, light transmittance of at a single wavelength of 562 nm was converted into an absorbance measurement (as illustrated in the chart of FIG. 14).

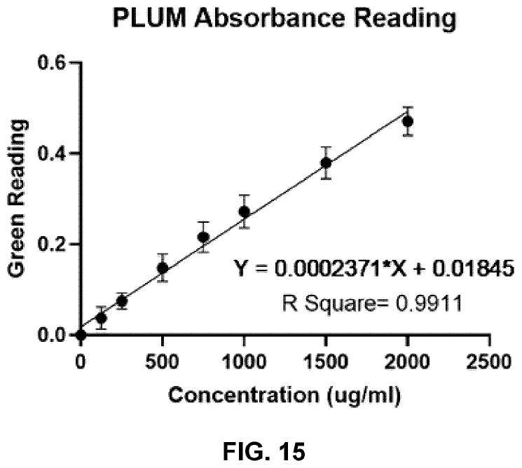

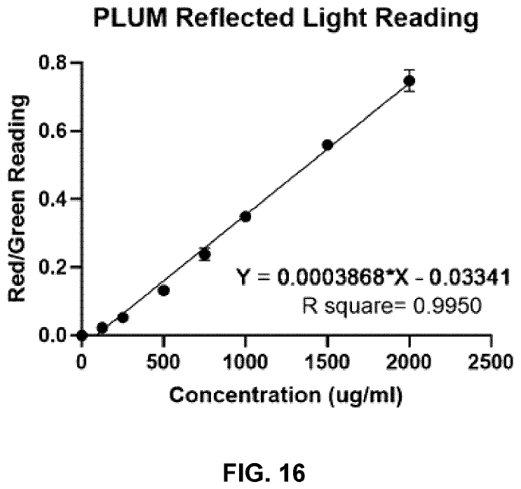

For the present system 100 (referred to as PLUM), two analysis approaches were tested. The first approach converted green channel values into an absorbance reading by monitoring the −log 10 value of the decrease in green light (illustrated in the chart of FIG. 15). In this case, the green channel reading was normalized using the blank BCA reading and the −log 10 value is plotted to invert the decrease in transmittance to the increase in absorbance. The second approach used the signal calculator, described herein, that determined a Red/Green ratio to plot a calibration curve (illustrated in the chart of FIG. 16). In this case, the Red over Green value is used to present the proportional relationship between the protein concentration and colour change. Three test samples with known protein concentrations were then separately calculated using each of the three calibration curves. As demonstrated in TABLE 1 and FIG. 16, when the R-squared value is used as a correlation metric, the signal calculator had the highest linearity. In addition, when the measurement accuracy was compared based on the expected concentration, the signal calculator showed the best result among these three techniques.

Results shown in TABLE 1 indicate that signal calculator employed by the system 100 can be used to accurately determine protein concentration with BCA assay. TABLE 1 illustrates results of the comparison of different measurement approaches using the system 100 and a commercial Biotek™ plate reader. Known concentration of analytes (280, 1450 and 1700 μg/m L) were analyzed by signal calculator and Beer-Lambert Law in the commercial reader. Experiments were conducted in triplicate. The system 100 using the signal calculator showed a higher R-squared value, less deviation among samples, and greater accuracy.

TABLE 1

| | | Calculated Final Value | | | Percent Accuracy | | |
|---|---|---|---|---|---|---|---|
| | | (ug/ml) | | | (%) | | |
| | Correlation | Sample | Sample | Sample | Sample | Sample | Sample |
| | R-square | #1 | #2 | #3 | #1 | #2 | #3 |
| Expected | ~1 | 280 | 1450 | 1700 | 100 | 100 | 100 |
| Plate Reader | 0.9926 | 315 ± 2 | 1201 ± 32 | 1471 ± 74 | 87.31 | 85.92 | 86.52 |
| Reading (Beer- | | | | | | | |
| Lambert Law | | | | | | | |
| based on 562 nm) | | | | | | | |
| PLUM | 0.9911 | 246 ± 47 | 1616 ± 67 | 2425 ± 166 | 87.7 | 88.52 | 57.3 |
| Absorbance | | | | | | | |
| Reading (Beer- | | | | | | | |
| Lambert Law on | | | | | | | |
| Green Channel) | | | | | | | |
| PLUM Reflected | 0.995 | 298 ± 10 | 1477 ± 36 | 1562 ± 60 | 93.61 | 98.14 | 91.87 |
| Light Reading | | | | | | | |
| (Signal | | | | | | | |
| Calculator on | | | | | | | |
| Red/Green Value) | | | | | | | |

TABLE 2 illustrates assay reading and calculation in the BCA assay for the example experiments. Raw data readings of calibration samples (125 μg/mL to 2000 μg/mL) and three unknown samples in a bicinchoninic acid assay. Data was collected from plate reader (562 nm absorbance) and the system 100 (Red, Green, Blue intensity). Calculation comparison used 1) the Beer-Lambert law for the plate reader reading and 2) green channel reading using the system 100 (referred to as PLUM), and 3) a signal calculator approach using reflected light (Red/Green) using the system 100 (referred to as PLUM).

TABLE 2

| | BCA Caliblibration Curve Reading | | | | | |
|---|---|---|---|---|---|---|
| | (Concentration ug/ml) | | | | | |
| | 2000 | 1500 | 1000 | 750 | 500 | 250 |
| Raw | plate reader 562 nm Reading | | | | | |
| Data | 0.945 | 0.765 | 0.606 | 0.508 | 0.396 | 0.245 |
| from | 1.011 | 0.852 | 0.604 | 0.509 | 0.392 | 0.229 |
| Plate | 1.176 | 0.825 | 0.675 | 0.549 | 0.401 | 0.251 |
| Reader | RGB Reading | | | | | |
| and | Red | | | | | |
| PLUM | 121.7665 | 134.0152 | 145.3858 | 150.5838 | 159.6701 | 169.7411 |
| | 112.4569 | 120.9137 | 136.9492 | 141.7462 | 150.0964 | 165.198 |
| | 102.1117 | 113.8122 | 123.8883 | 130 | 140.0203 | 157.1777 |
| | Green | | | | | |
| | 71.18274 | 89.2132 | 112.269 | 126.2843 | 148.4873 | 170.264 |
| | 65.7868 | 79.8731 | 106.467 | 121.9797 | 140.0711 | 166.2234 |
| | 61.67005 | 76.19289 | 95.39594 | 108.9594 | 129.2995 | 157.2741 |
| | Blue | | | | | |
| | 141.401 | 146.5279 | 150.3503 | 152.6193 | 159.3046 | 165.8274 |
| | 136.1117 | 137.0609 | 143.2335 | 146.6802 | 151.3807 | 162.599 |
| | 126.868 | 129.7208 | 134.3553 | 135.3249 | 141.5635 | 154.264 |

Calculated Using Three Methods
(1) Plate Reader Absorbance Reading

| | | | | | | |
|---|---|---|---|---|---|---|
| Average | 0.939333 | 0.709333 | 0.523667 | 0.417333 | 0.291667 | 0.137 |
| STD | 0.118983 | 0.044531 | 0.040427 | 0.023388 | 0.004509 | 0.011372 |

(2) PLUM Abosorbance Reading (Green Channel Alone Reading)

| | | | | | | |
|---|---|---|---|---|---|---|
| Average | 0.471047 | 0.379661 | 0.272241 | 0.216275 | 0.148031 | 0.075085 |
| STD | 0.031201 | 0.035168 | 0.036073 | 0.033509 | 0.030169 | 0.017675 |

(3) PLUM Reflected Light Reading (Red/Green Reading)

| | | | | | | |
|---|---|---|---|---|---|---|
| Average | 0.747759 | 0.559074 | 0.349144 | 0.238348 | 0.132424 | 0.05254 |
| STD | 0.031322 | 0.010084 | 0.006348 | 0.017736 | 0.005779 | 0.002784 |

| | BCA Caliblibration Curve Reading | | | | |
|---|---|---|---|---|---|
| | (Concentration ug/ml) | | Unknown Sample Reading | | |
| | 125 | 0 | 1 | 2 | 3 |
| Raw | plate reader 562 nm Reading | | | | |
| Data | 0.162 | 0.094 | 0.29 | 0.661 | 0.85 |
| from | 0.167 | 0.125 | 0.289 | 0.784 | 0.854 |
| Plate | 0.168 | 0.095 | 0.292 | 0.755 | 0.9 |
| Reader | RGB Reading | | | | |
| and | Red | | | | |
| PLUM | 181.4264 | 190.5787 | 177.8426 | 139.467 | 83.50761 |
| | 175.1675 | 183.7665 | 173.6041 | 129.0863 | 91.08122 |
| | 163.7411 | 179.533 | 166.0609 | 132.5838 | 109.6396 |
| | Green | | | | |
| | 187.934 | 201.8731 | 172.2995 | 93.84772 | 55.91878 |
| | 181.9442 | 194.7107 | 169.8426 | 84.35025 | 57.75635 |
| | 168.4061 | 190.0457 | 160.3756 | 89.08629 | 71.37563 |
| | Blue | | | | |
| | 175.5482 | 183.1421 | 179.2792 | 159.1827 | 104.9239 |
| | 170.3604 | 176.6904 | 174.3706 | 143.2538 | 108.802 |
| | 158.1675 | 170.203 | 165.1168 | 140.1472 | 121.9949 |
| Calculated Using Three Methods | | | | | |
| (1) Plate Reader Absorbance Reading | | | | | |
| Average | 0.061 | 0 | 0.185667 | 0.650833 | 0.763333 |
| STD | 0.003215 | 0.017616 | 0.001528 | 0.064299 | 0.027785 |
| (2) PLUM Abosorbance Reading (Green Channel Alone Reading) | | | | | |
| Average | 0.037809 | 0 | 0.06742 | 0.341802 | 0.503673 |
| STD | 0.024481 | | 0.016479 | 0.023171 | 0.057571 |
| (3) PLUM Reflected Light Reading (Red/Green Reading) | | | | | |
| Average | 0.022633 | 0 | 0.085747 | 0.557398 | 0.59131 |
| STD | 0.004932 | 0.000458 | 0.006931 | 0.024953 | 0.041812 |

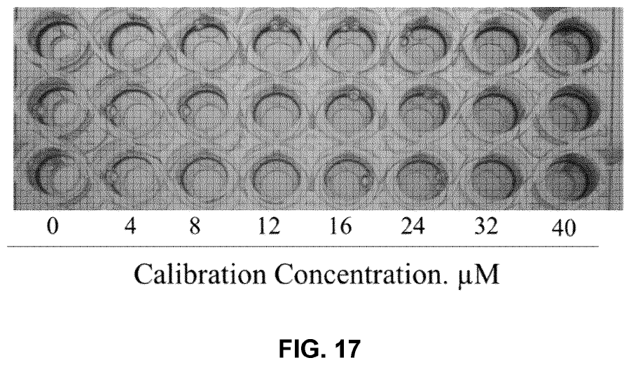

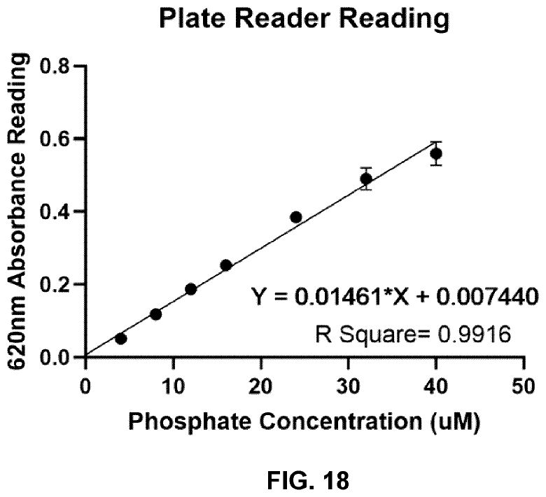

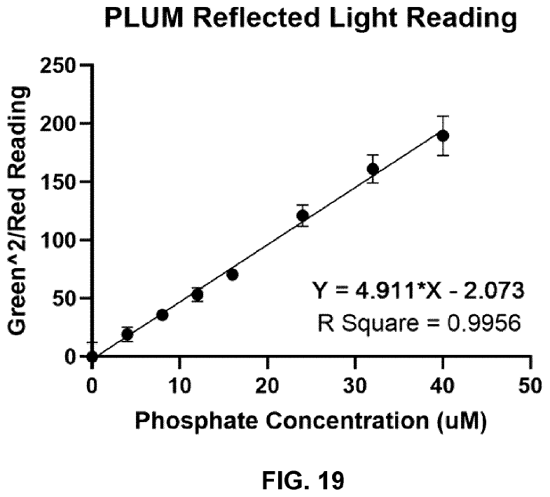

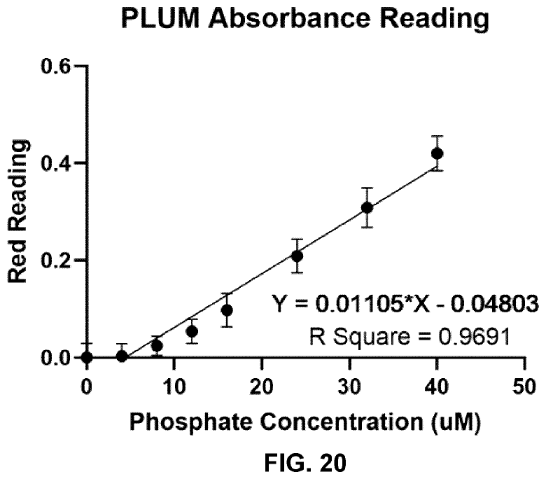

In further example experiments, to further validate the approach of the system 100, the present inventors performed a malachite green assay using the Beer-Lambert method and the signal calculator, described herein. The malachite green assay generates a colour change, from green to purple, in the presence of phosphate (as illustrated in the example of FIG. 17). A titration of phosphate concentration (4 μM to 40 μM) was used to create calibration curves for analysis using the Beer-Lambert method in a plate reader according to other approaches and the signal calculator and Beer-Lambert methods in the present system 100. The absorbance of the 620 nm wavelength was monitored in the plate reader, which resulted in a calibration curve with a R squared value equal to 0.9916 (as illustrated in the chart of FIG. 18). For the system 100, since the wavelength of 620 nm falls into the peak of red channel sensitivity, the decrease of red channel intensity was plotted based on the Beer-Lambert law. Using the signal calculator, the system 100 generated a R squared value of 0.9956 for the titration of phosphate samples (as illustrated in the chart of FIG. 19). The use of the Beer-Lambert method with PLUM measurements resulted in a R squared value of 0.9691 (as illustrated in the chart of FIG. 20). The signal calculator was shown to have comparable a R squared value with the plate reader while having the best linearity.

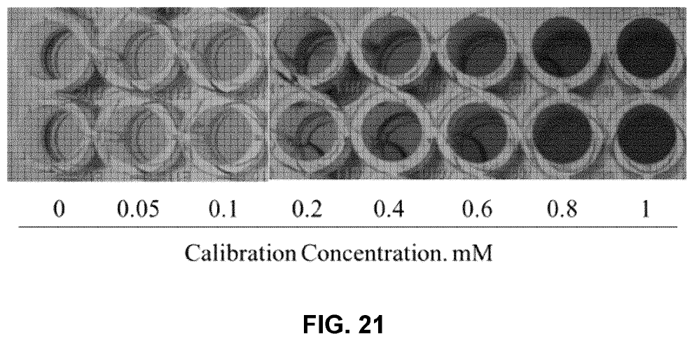

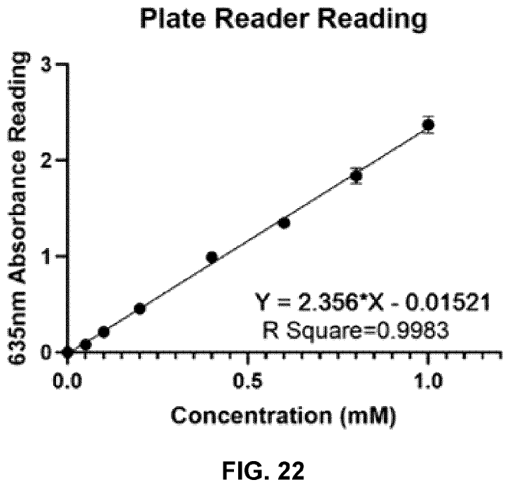

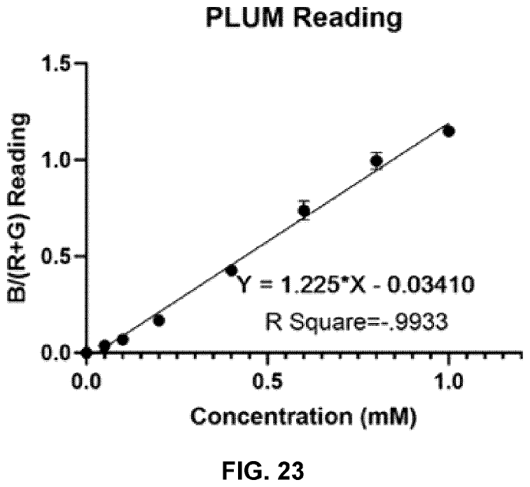

In further example experiments, to further validate the approach of the system 100, the present inventors used an ammonium assay. An ammonium assay is another example of a simple colorimetric assay that is used for ammonia/ammonium quantification. The assay is based on the phenol hypochlorite assay, known as Berthelot reaction, where a blue indophenol substance formed based on the presence of ammonium in the solution (as illustrated in the example of FIG. 21). This assay can be used for internal ammonium quantification in plant tissues, and in clinal usage for screening of patient liver dysfunction. Using an ammonium titration of 0.05 mM to 1 mM, the calibration curve generated by a conventional plate reader had a R squared value of 0.9983 for measurement of an ammonium titration in the assay at a wavelength of 635 nm (as illustrated in the chart of FIG. 22). The calibration curve generated by the system 100 using the signal calculator for measurement of an ammonium titration using Blue/(Red+Green) values had a R squared value of 0.9933 (as illustrated in the chart of FIG. 23). The signal calculator in this example experiment used Blue over the addition of Red and Green values to represent the colour-shift from yellow to blue. Thus, the two calibration curves had comparable R squared values.

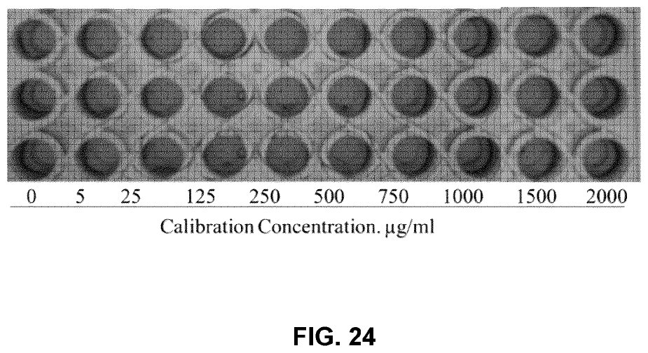

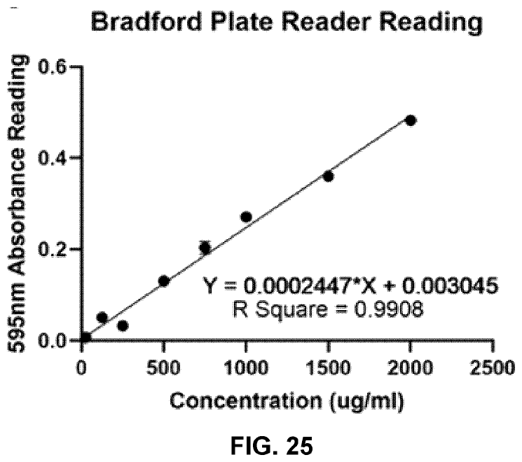

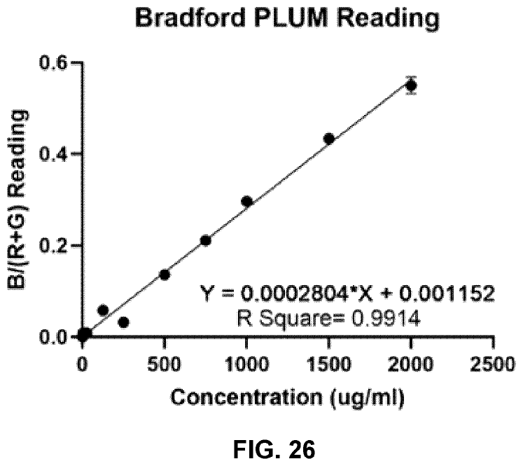

In further example experiments, to further validate the approach of the system 100, the present inventors used a Bradford assay for protein quantification. This assay used Coomassie dye, which changes from brown to blue with the presence of protein in a linear manner (as illustrated in the example of FIG. 24). A titration of protein concentration (5 μg/mL to 2000 μg/mL) exhibited a proportional relationship to absorbance at 595 nm using the plate reader according to other approaches. Similar results were found with the system 100 using the signal calculator, and the R-squared values from both devices indicating little variance in measurements. FIG. 25 illustrates a chart for measurement of protein concentrations using 595 nm absorbance in the plate reader and FIG. 26 illustrates a chart for measurement of protein concentrations using Blue/(Red+Green) value in accordance with the signal calculator of the system 100.

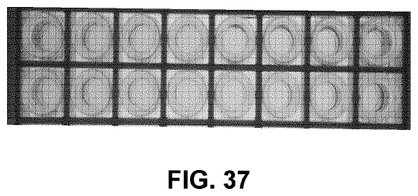

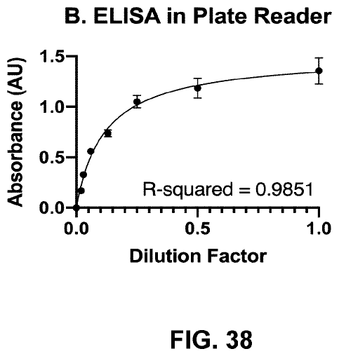

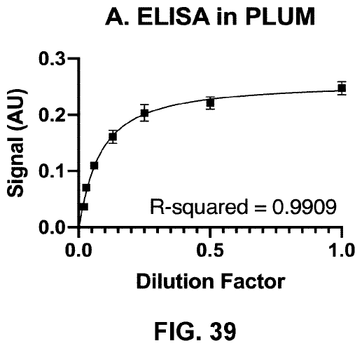

In further example experiments, to further validate the approach of the system 100, the present inventors used a type of immune-assay called an Enzyme-linked immunosorbent Assays (ELISAs). This technique uses antibody-specific labeling (e.g. an enzyme-linked antibody) to provide concentration-dependent detection of target analytes (as illustrated in the example of FIG. 37). In these example experiments, ELISA is performed for the detection of 3,3′,5,5′-Tetramethylbenzidine (TMB) and the resulting signal is measured using a commercial plate reader (as illustrated in the example of FIG. 38) and using the system 100 (as illustrated in the example of FIG. 39).

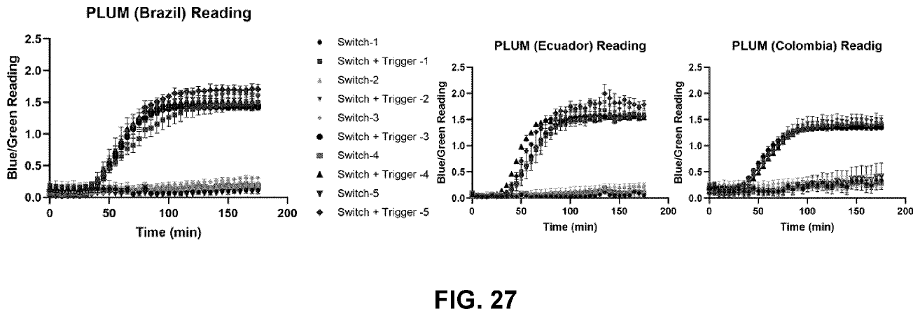

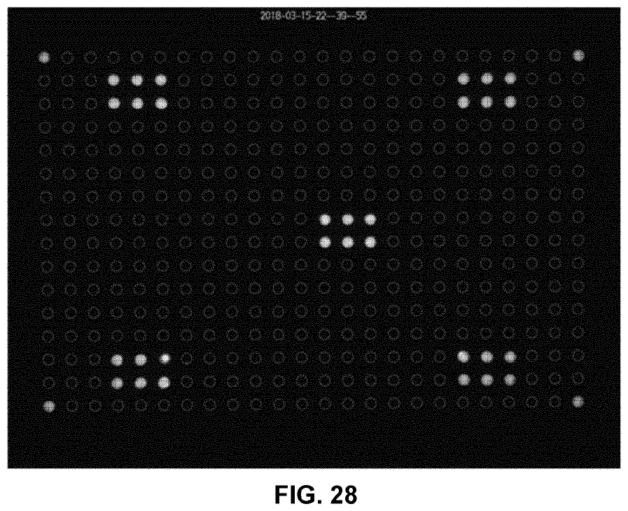

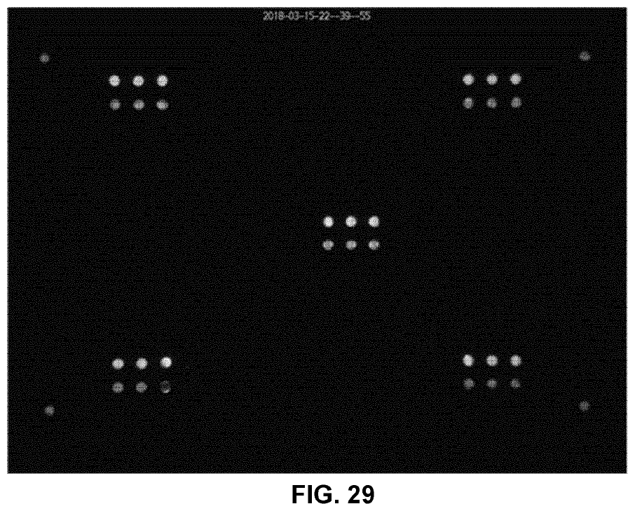

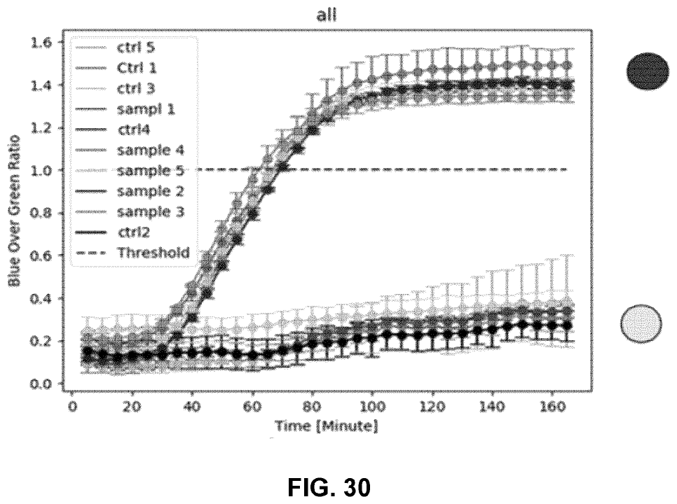

In further example experiments, to further validate the approach of the system 100, the present inventors deployed the system using paper-based assays. In these example experiments, reactions were performed in-field using synthetic Zika virus RNA. The assay used a colour shift from yellow to purple to indicate the presence of target RNA. To represent this colour change, the signal calculator used reflected light readings employing Blue channel values over Green channel values to track assay reaction progress over time. The system 100 demonstrated consistent reading within the whole plate regardless of well position; as illustrated in FIG. 27 showing in-field readings from three different countries (Brazil, Ecuador, and Columbia). To test the uniformity of illumination in the system 100, five pairs of reactions were placed in a 384 well plate. Four of the reactions were positioned in proximity to the corners while a fifth reaction was positioned in the middle. For each pair of reactions, the top set of triplicate reactions were negative, and the bottom set was positive. By recognizing four corner makers in the initial captured plate image, the system 100 generated a ROI (regions of interest) map where well locations are circled as regions of interest; as illustrated in FIG. 28. Colour change across the whole plate was monitored over 3 hours during which time positive reactions turned purple and negative reactions remained yellow; as illustrated in FIG. 29. The identification of the reactions was defined by users via the user interface 108. The user-defined map was then automatically combined with the recorded colour change to generate a quantitative report as indicated in FIG. 30. The pre-set threshold value was indicated as a dashed line to help users to differentiate positive and negative reactions. The results were then exported.

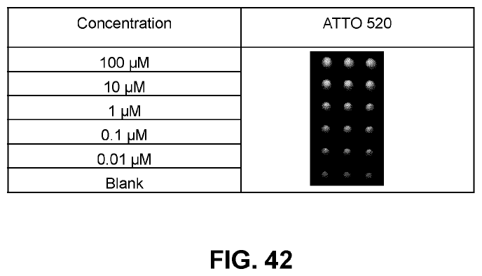

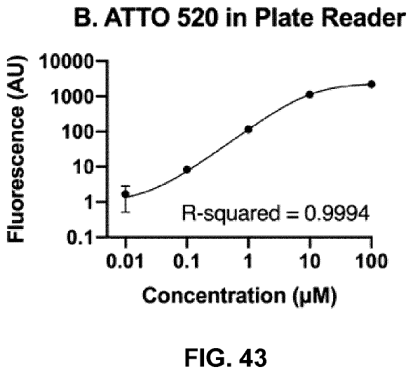

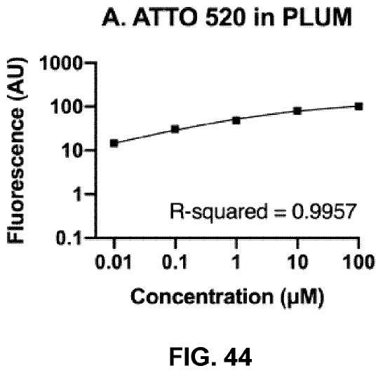

In further example experiments, to further validate the approach of the system 100, the present inventors used ATTO 520 dyes. This technique uses dilutions of fluorescent dyes from 100 to 0.01 micromolar concentrations to provide detection of fluorescent dye concentration (as illustrated in the example of FIG. 42). In these example experiments, the ATTO 520 signal is measured using a commercial plate reader (as illustrated in the example of FIG. 43) and using the system 100 (as illustrated in the example of FIG. 44).

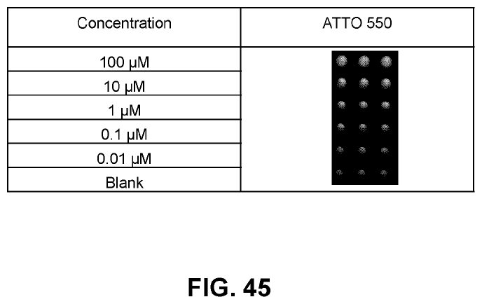

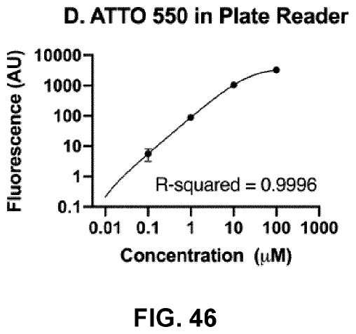

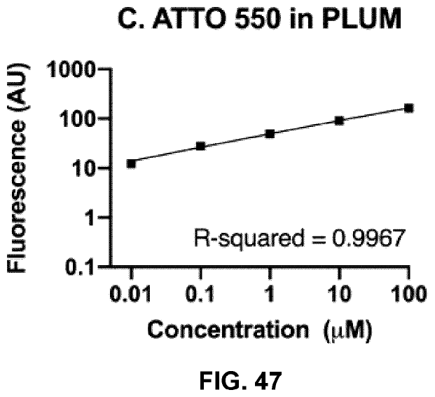

In further example experiments, to further validate the approach of the system 100, the present inventors used ATTO 550 dyes. This technique uses dilutions of fluorescent dyes from 100 to 0.01 micromolar concentrations to provide detection of fluorescent dye concentration (as illustrated in the example of FIG. 45). In these example experiments, the ATTO 550 signal is measured using a commercial plate reader (as illustrated in the example of FIG. 46) and using the system 100 (as illustrated in the example of FIG. 47).

In some embodiments, the system 100 can be applied as a gel documentation system in colorimetric, fluorescent, and luminescent mode. The present inventors conducted example experiments to compare the performance of the system 100 against a commercial imager (ChemiDoc-IT™ Gel documentary system by Bio-Rad™).

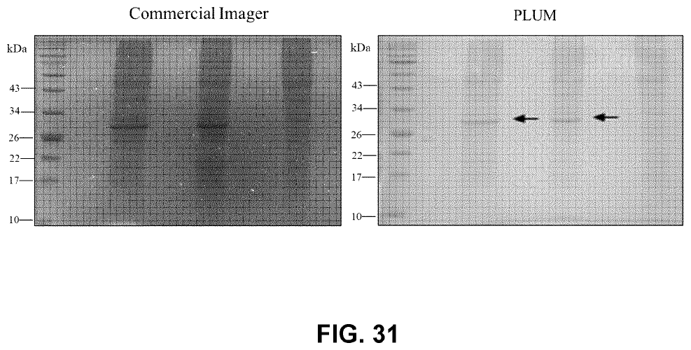

SDS-PAGE is an analytic biochemical technique that uses electrophoresis through an acrylamide gel to separate proteins according to molecular mass. This technique is commonly used to visualize and detect the expression of a protein of interest. The example experiments used an ALiCE cell-free solution containing enhanced yellow fluorescent protein (eYFP) run in SDS-PAGE. As illustrated in FIG. 31, the system 100 (referred to as PLUM) is compared to the output from the commercial imager. The system 100 can be used to visualize the band of interest, as indicated by the arrows. The gel was stained with EZBlue™ Gel Staining Reagent that enables visualization of the proteins. In the system 100, the broad-spectrum white light is used to illuminate the gel tray and no filter needs to be used.

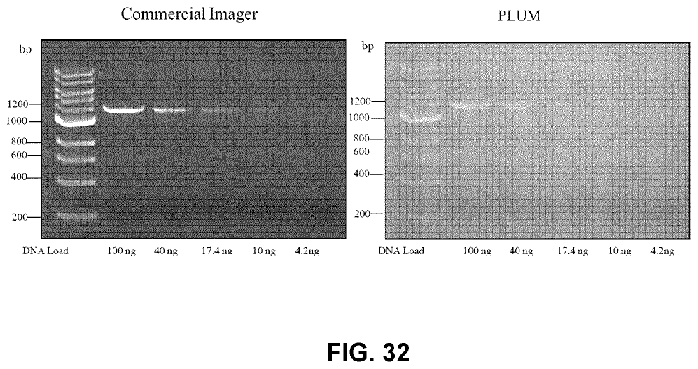

Agarose gel electrophoresis is used to separate DNA/RNA fragments and helps scientists to detect or purify target oligonucleotides. The example experiments used an agarose gel with wells containing a sequential titration of 4.2 ng, 10 ng, 17.4 ng, 40 ng and 100 ng of DNA. This was imaged by the system 100 with the combination of coloured LED and a specialized filter. The staining solution has a visible excitation between the wavelengths 419 nm and 513 nm, and an emission wavelength at 540 nm. The excitation of the fluorescence dye was achieved in the system 100 using the Royal Blue coloured LED which has a narrow peak band at 440 to 460 nm. A longpass filter with cut-off wavelength at 515 nm was used to block the background light, only transmitting emission wavelengths through to the camera. As shown in the comparison of FIG. 32, the system 100 can detect DNA concentration greater than 17.4 ng per lane. This is lower than the typical practice of loading 50 ng of DNA per lane, meaning that the system 100 can provide practical support to many DNA gel imaging applications.

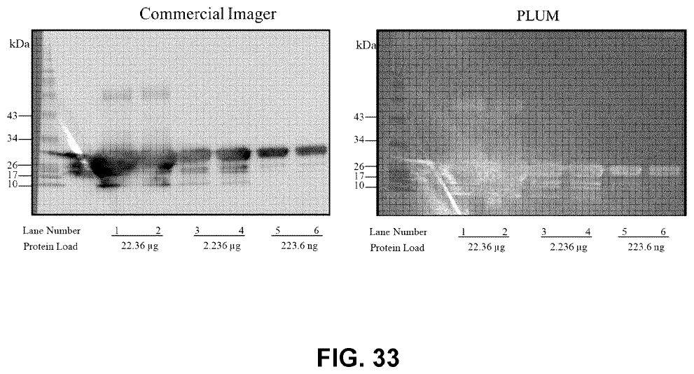

The western blot technique can be used for the detection of target protein among a mixture of proteins in an SDS-PAGE gel. The target protein can be visualized using the appropriate primary antibody, specific to the target protein, and a secondary antibody, specific to the primary antibody and carries a chemiluminescent reporter enzyme. The chemiluminescent substrate used in the example experiments emits a blue/green light once activated by the conjugated enzyme to the secondary antibody. Using a titration (10 ng to 30 μg per well) of green fluorescence protein (GFP) into the wells of an SDS-PAGE gel and electrophoresis, a western blot was performed and imaged using the system 100. As illustrated in the comparison of FIG. 33, the result indicates that the system 100 can document immunofluorescent bands down to at least 224 ng/well of target protein.

In example experiments, the system 100 was used to conduct patient filed trials to detect the Zika virus. 268 patient samples were collected and examined with the system 100. As described above, the system 100 was used to quantify the colour change (yellow to purple) generated by toehold switches in paper-based reactions. The example experiments were compared with qRT-PCR detection to provide comparison to an industry standard.

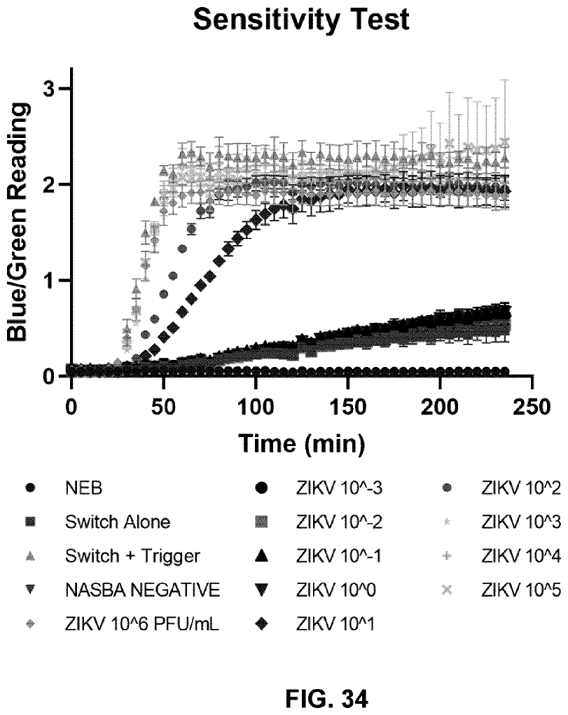

To determine the sensitivity, a serial dilution of the Zika virus was tested in parallel using qRT-PCR and the system 100 monitoring of Zika virus toehold switch cell-free reactions. All the samples were amplified by NASBA before being added to the cell-free reaction. In qRT-PCR testing, Zika virus titrations between 10⁵ to 10¹ PFU/mL were determined as positive, with the threshold value set at a Ct (threshold cycle) of 38. In the system 100 readings of the toehold switch reactions, a clear separation around at 50 min started showing; as illustrated in FIG. 34. By the endpoint of the Zika sensor reading (240 minutes), all the qPCR positive samples turned purple (positive) while all the qPCR negative samples remained yellow (negative). Considering similar results obtained from three independent toehold switch/PLUM experiments, the detection sensitivity for the system 100 was determined to be 10¹ PFU/mL; which is equivalent to the sensitivity of qRT-PCR.

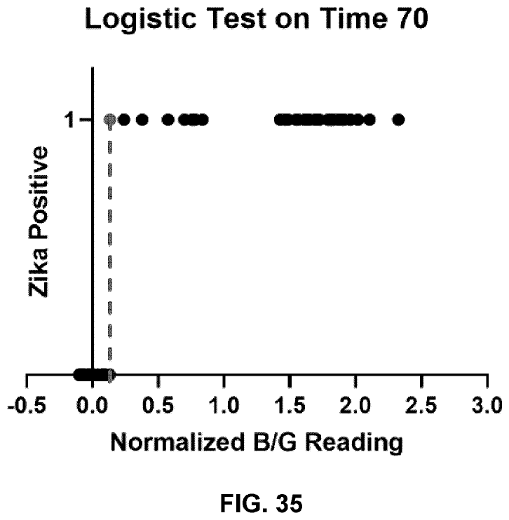

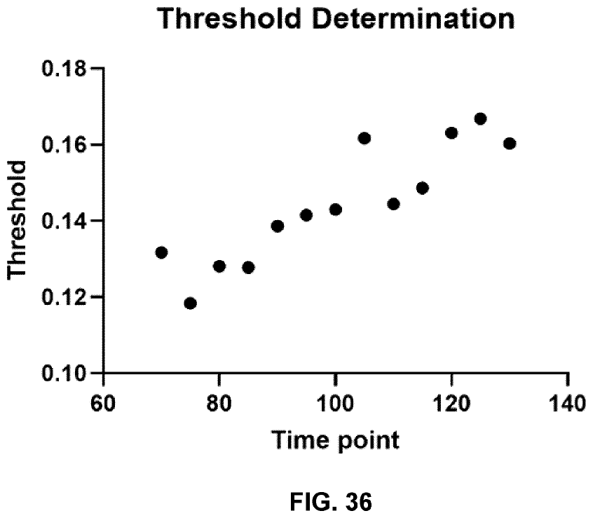

Based on the above sensitivity data, a threshold was determined for measurement of the diagnostic performance of Zika virus toehold switch-based sensors from patient serum samples. A logistic test was performed using Zika positive and Zika negative data as confirmed by both qRT-PCR and the system 100. Reactions with triplicates were considered as individual data points to increase to sample size for more precise analysis. All sample data was normalized by subtracting the NASBA negative values in each run. By running a logistic test, the differences between the blue/green values for Zika positive samples and zika negative samples become statistically significant at 70 minutes and onwards. At each time point, the values of positive samples were beyond the threshold that can be classified as ZIKV+. As illustrated in FIG. 35, at different time points, the threshold fluctuates but permits clear discrimination of positive and negative samples from sensitivity tests. Logistic analysis was performed on thirteen timepoints from 70 minutes to 130 minutes and values fell in the range from 0.1183366 to 0.1668622. As the Blue/Green reading of ZIKV+sample increases, threshold values increase correspondingly; as illustrated in FIG. 36.

Using the determined threshold value, the Zika virus status of patient samples analysis was conducted using 268 patient samples. For each experiment, several positive and negative samples were included. The original status of ZIKV+ or ZIKV− samples was retracted in PLUM and qPCR experiments so that that the present inventors were blinded to sample identity to remove any bias. With 268 patient samples analyzed, diagnostic performance of the RNA sensor and PLUM were analyzed against each threshold from 70 minutes timepoint to 130 minutes timepoint. After 75 minutes, the diagnosis accuracy reached above 98%. Based on the thresholds from 75 minutes to 130 minutes (except at 105 minutes), there were 69 samples with a ZIKV positive reading in both qPCR and the system 100 (referred as true positive) and 195 samples with a ZIKV negative reading in both qPCR and the system 100 (referred as true negative). Four of the patient samples were determined positive in qPCR test but were not recognized by the system 100 using the current threshold. Based on the experiment, the diagnostic of Zika patient sample can be determined at 75 minutes using the toehold switch-based sensor and the system 100. The true positive rate and true negative rate was determined to be 94% and 100%, respectively.

In further embodiments, data outputted by the system 100 could be used in image detection of samples and passed to a trained machine learning model to improve accuracy of detection.

Despite the high demand, cost remains a significant factor that limits access to plate readers and imagers for optical measurement and characterization. The present embodiments advantageously provide a camera-based, multi-mode electronic reader as a low-cost implementation to provide an affordable system. As illustrated in the example experiments, the system 100, using the present approach to absorbance measurements, is especially suitable for applications where cost currently limits access to the plate reader capabilities. As an example, an embodiment of the current system costs around $400 Canadian while a commercial plate reader (BioTek™ Neo 2) costs around $70,000 Canadian.

In some cases, users can easily build new layers of code to customize the system 100 to their own needs. This includes customization of assay set-up and data analysis. This allows users makes it possible to quickly respond to emergent increase demand for specific assays and may allow researchers or clinicians to have more bandwidth to handle the requirements of an experiment.

In some cases, the output of the system 100 can be exported to a cloud computing storage. In such cases, for example, the output can serve as an interactive education tool for science classrooms. In such cases, for example, the output can be used as a collaborative science platform to facilitate collaboration among groups located in different areas by providing easier access to data. In some cases, the on-board controller 102 allows for easy servicing by remotely logging into the systems 100; which enables faster troubleshooting and provides better customer service.

In addition to the applications described herein, it is appreciated that there exists and can exist many other suitable applications for the system 100. As an example, the system 100 can be used for: monitoring quantitative isothermal amplification-based diagnostic; digital alternative for pH measurement; tracking, detection and quantification of small objects (e.g., optical screw categorization of thread size, length and number for industry); and the like.

Advantageously, embodiments of the present disclosure allow for the use of commonplace LEDs and commonplace cameras/image-sensors instead of expensive specialized single-wavelength light emitters and sensors typically used in plate readers and gel imagers. Also advantageously, the embodiments of the present disclosure allow for the detection of the presence of a molecule by using multiple illuminations by different LEDs, coupled with appropriate filters in front of a camera, in order to arrive at fluorescence measurements. The ratio of these measured levels (shifts in RGB channel levels over time, and across channels) can be used to arrive at an equivalent absorption measurement by comparing the measured levels to calibration curves. This is in contrast to other approaches that use single or multiple illuminations by a single light source to measure absorption or fluorescence, which generally provides less accuracy.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A system for characterization of an assay from a plurality of regions of interest (ROI) on an assay housing, the system comprising:
an illumination source to illuminate the ROI;
a camera to receive image data of the assay from the plurality of ROI, the image data comprising at least two color channels for each ROI; and
a controller comprising one or more processors and a memory, the one or more processors configured to execute:
a measurement module to determine a ratio of signal change across the color channels for each ROI and convert the ratio of signal to a concentration determination of the assay using a calibration curve, the calibration curve determined from image data of a calibration assay with known concentrations; and
an output module to output the concentration determination for each ROI.

2. The system of claim 1, wherein the illumination source comprises a broadband light source with uniform intensity for colorimetric assays.

3. The system of claim 1, wherein the illumination source comprises narrowband excitation light source in combination with an emission filter for fluorescent assays.

4. The system of claim 1, wherein the concentration determination is determined by comparing to calibration curve concentrations at end-point readings or comparing to calibration curve concentrations over time-course reactions.

5. The system of claim 1, wherein receiving image data of the assay from the plurality of ROI comprises at least one of absorbance, fluorescence, or luminescence readings.

6. The system of claim 1, wherein the system performs functions of at least one of a plate reader and a gel imager.

7. The system of claim 1, further comprising thermal components for on-site incubation using heat convection, conduction, or radiation.

8. The system of claim 1, further comprising landmarks associated with the assay housing for ROI location identification by the controller.

9. The system of claim 7, wherein the landmarks comprise markers positioned on a plate carrier of the assay housing or on four corners of a multi-well plate of the assay housing, and wherein the controller recognizes the landmarks and aligns the landmarks to digital template images of multi-well plates to determine the location of the plurality of ROI.

10. The system of claim 1, further comprising barcodes associated with the assay housing to determine sample types and analysis protocol by the controller.

11. The system of claim 1, further comprising an opaque film located in front of the camera to block unwanted light.

12. The system of claim 1, wherein the plurality of ROI in the image data can be dynamically defined.

13. A method for characterization of an assay from a plurality of regions of interest (ROI), the method comprising:
receiving image data of the assay from the plurality of ROI during illumination, the image data comprising at least two color channels for each ROI;
determining a ratio of signal change across the color channels for each ROI;
converting the ratio of signal change for each ROI to a concentration determination of the assay using a calibration curve, the calibration curve determined from image data of a calibration assay with known concentrations; and
outputting the concentration determination for each ROI.

14. The method of claim 13, wherein the illumination comprises a broadband light source with uniform intensity for colorimetric assays.

15. The method of claim 13, wherein the illumination comprises narrowband excitation light source in combination with an emission filter for fluorescent assays.

16. The method of claim 13, wherein the concentration determination is determined by comparing to calibration curve concentrations at end-point readings or by comparing to calibration curve concentrations over time-course reactions.

17. The method of claim 13, wherein receiving image data of the assay from the plurality of ROI comprises at least one of absorbance, fluorescence, or luminescence readings.

18. The method of claim 13, wherein the ratio of signal change comprises a ratio of a sum of increasing channel values over a sum of decreasing channel values.

19. The method of claim 13, wherein converting the ratio of signal change for each ROI to the concentration determination comprises using single value decomposition to map known concentration data samples collected from a dilution series of end-point reactions to determine unknown samples.

20. The method of claim 13, wherein determining the ratio of signal change comprises training an artificial intelligence model with time series reaction data to determine a function that has a consistent increase over time and provides best linearity for the final point in time.
